(19) United States
(12) Patent Application Publication
(10) Pub. No.: US 2016/0162992 A1
(43) Pub. Date: Jun. 9, 2016

(54) SYSTEM AND METHOD FOR GENERATING A LIFE PLAN FOR PEOPLE WITH DISABILITIES VIA A GLOBAL COMPUTER NETWORK

(71) Applicant: WILLIAM ENGLAND, South River, NJ (US)

(72) Inventor: WILLIAM ENGLAND, South River, NJ (US)

(21) Appl. No.: 14/563,534

(22) Filed: Dec. 8, 2014

(51) Int. Cl. G06Q 40/06; H04L 29/08

(52) U.S. Cl. CPC G06Q 40/06; H04L 67/306

(57) ABSTRACT

Embodiments of the present invention generally relate to a computer-implemented system and method for generating a life plan via a global-computer network. In one embodiment, a computer-implemented method for generating a life plan via a global-computer network comprises receiving a request to create a user account from an entity, and creating the user account; receiving a request from the user account to create a common profile, the common profile associated with the disabled individual; generating the common profile and receiving a set of profile data from the user account, the set of profile data comprising information related to the disabled individual and associated with the common profile; and analyzing the common profile and generating a life plan based on the common profile, the life plan comprising data related to providing guidance to the entity to allow the disabled individual to lead a productive life.

### BACKGROUND

1. Field of the Invention

Embodiments of the present invention generally relate to a system and method for generating a life plan for people with disabilities via a global computer network. More specifically, embodiments of the present invention generally provide a system of collecting, monitoring, and analyzing data from multiple sources, the data related to activities, capabilities, and skills of disabled and/or dependent persons, saving the data in a common profile, generating a life plan based on the collected data.

2. Description of Related Art

People with disabilities often need extensive support that begins when the disability is diagnosed, a need which often lasts a lifetime. Some disabilities begin at birth, while others are a result of an injury or illness later in life. As awareness of the needs of people with disabilities has increased society has significantly expanded the support available to people with disabilities.

Although the support programs available to people with disabilities has increased, multiple programs often have non-uniform eligibility requirements for access to these programs. One example of this is the various government social service systems, or the like. A person with disabilities and their families must be aware of, apply for, and be approved for, each specific service in order to secure maximum support. In addition, in an era of diminishing government resources, it is critical that families effectively supplement the services of government with personal and family support to insure their loved one has the resources to live a happy and productive life. To effectively access government services, and the like, and to supplement these services with family resources, requires knowledge and planning.

There currently exists no centralized way to store, access, analyze, and transmit data related to the behavior, skills, and/or the like of people with disabilities to ensure optimal and/or maximum support and creation of an effective life plan. An effective life plan may include a coordinated and life-long plan on how to access, use and structure personal, government, and family resources to lead as happy, independent and productive life, as possible. Thus, a need exists for an improved system and method for generating a life plan for people with disabilities via a global computer network.

### SUMMARY

Embodiments of the present invention generally relate to a system and method for generating a life plan for people with disabilities via a global computer network. In one embodiment of the present invention, a computer-implemented method for generating a life plan for people with disabilities via a global computer network may comprise, at a computing device having one or more processors and memory, storing one or more programs for execution by the one or more processors; receiving a request to create a user account from an entity and creating the user account; receiving a request from the user account to create a common profile, the common profile associated with the disabled individual; generating the common profile and receiving a set of profile data from the user account, the set of profile data comprising information related to the disabled individual and associated with the common profile; and analyzing the common profile and generating a life plan based on the common profile, the life plan comprising data related to providing guidance to the entity to allow the disabled individual to lead a productive life and increase the independence of the disabled individual.

In another embodiment of the present invention, a computer-implemented method for generating a life plan for people with disabilities via a global computer networks is provided that may comprise: at a computing device having one or more processors and memory storing one or more programs for execution by the one or more processors: receiving a request to create a user account from an entity and creating the user account; receiving a request from the user account to create a common profile, the common profile associated with the disabled individual; generating the common profile and receiving a set of profile data from the user account, the set of profile data comprising information related to the disabled individual and associated with the common profile; analyzing the common profile and generating a life plan based on the common profile, the life plan comprising data related to providing guidance to the entity to allow the disabled individual to lead a productive life and increase the independence of the disabled individual; determining that the disabled individual qualifies for a support program based on the common profile and requirements received from the support program; generating an application for support from the support program using the common profile; transmitting the application to the support program; and monitoring the application and generating a notification if the application is approved or denied.

In yet another embodiment of the present invention, a computer-implemented method for generating a life plan for people with disabilities via a global computer networks is provided that may comprise: at a computing device having one or more processors and memory storing one or more programs for execution by the one or more processors: receiving a request to create a user account from an entity and creating the user account; receiving a request from the user account to create a common profile, the common profile associated with the disabled individual; generating the common profile and receiving a set of profile data from the user account, the set of profile data comprising information related to the disabled individual and associated with the common profile; analyzing the common profile and generating a life plan based on the common profile, the life plan comprising data related to providing guidance to the entity to allow the disabled individual to lead a productive life and increase the independence of the disabled individual; receiving a request to create a second user account from a second entity and creating the second user account; receiving a second set of profile data from the second user account, the second set of profile data comprising information related to the disabled individual and associated with the common profile; and analyzing the common profile and generating an updated life plan based on the common profile.

### BRIEF DESCRIPTION OF THE DRAWINGS

So the manner in which the above recited features of the present disclosure can be understood in detail, a more particular description of embodiments of the present disclosure, briefly summarized above, may be had by reference to embodiments, which are illustrated in the appended drawings. It is to be noted, however, the appended drawings illustrate only typical embodiments of embodiments encompassed within the scope of the present disclosure, and, therefore, are not to be considered limiting, for the present disclosure may admit to other equally effective embodiments, wherein:

FIG. 1 depicts a system-level network diagram of a system for generating a life plan in accordance with embodiments of the present invention;

FIG. 2 depicts a block diagram of a general computer system, which is capable of being used in connection with the system depicted in FIG. 1, in accordance with embodiments of the present invention;

FIG. 3 depicts a block diagram illustrating a system for generating a life plan in accordance with embodiments of the present invention;

FIG. 4 depicts an exemplary client computer capable of being used with the system depicted in FIG. 1, in accordance with embodiments of the present invention;

FIG. 5 depicts an exemplary administrative interface in accordance with embodiments of the present invention;

FIG. 6 depicts an exemplary profile interface, in accordance with embodiments of the present invention;

FIG. 7 depicts an exemplary calendar interface, in accordance with embodiments of the present invention;

FIG. 8 depicts an exemplary plan interface, in accordance with embodiments of the present invention;

FIG. 9 depicts an exemplary report interface, in accordance with embodiments of the present invention; and

FIG. 10 depicts a flow diagram illustrating a method of generating a life plan in accordance with embodiments of the present invention.

The headings used herein are for organizational purposes only and are not meant to be used to limit the scope of the description or the claims. As used throughout this application, the word may is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures.

### DETAILED DESCRIPTION

Embodiments of the present invention generally relate to a system and method for generating a life plan for people with disabilities via a global computer network. More specifically, embodiments of the present invention generally provide a system of collecting, monitoring, and analyzing data from multiple sources, the data related to activities, capabilities, and skills of disabled and/or dependent persons, saving the data in a common profile, generating a life plan based on the collected data.

As used herein, the terms any of followed by a listing of a plurality of items and/or a plurality of categories of items, as used herein, are intended to include any of,” “any combination of,” “any multiple of,” and/or “any combination of multiples of ” the items and/or the categories of items, individually or in conjunction with other items and/or other categories of items. In addition, as used herein, the term “set” is intended to include any number of items, including zero. Further, as used herein, the term “number” is intended to include any number, including zero. Also, as used herein, the article “a” is intended to include one or more items.

In accordance with certain embodiments of the present invention, methods disclosed herein may occur in “real-time.” Real-time is utilized herein as meaning near-instantaneous, subject to minor delays caused by network transmission and computer processing functions, and able to support various input and output data streams.

A system in accordance with embodiments of the present disclosure may be adapted to provide active case management, support brokering and financial coordination services to people with developmental disabilities, brain injury, significant physical disabilities, mental illness, and/or the like. The system may be adapted to help people with disabilities and the families that support them lead productive, independent lives. The system may provide various life planning or support coordination services via a global computer network, or the like. In some embodiments, the system may comprise a means of directly contacting a counselor, or the like, via an interface, such as a chat interface, a video chat interface, an audio chat interface, a text chat interface, an email interface, and/or the like. In exemplary embodiments of the present disclosure, a plurality of parties may enter data about a person with disabilities and various different times and/or simultaneously and the system may collect data from the various parties and formulate a life plan, or the like. In some embodiments, the system may be adapted to track how the person with disabilities behaves and their tendencies when interacting with certain individuals, groups, combinations of individuals, and/or combinations of groups, or the like.

People with developmental disabilities, mental illness, brain injuries, serious physical disabilities and seniors with disabilities, along with the families, caregivers, and organizations supporting them have the greatest need for life planning. Life planning generally comprises a process of determining who a person with disabilities is, what supports they need and how to access, use and structure personal, government, and family resources to lead as happy, independent and productive life, as possible. Who a person with disabilities is may comprise their skill sets, personality traits, physical or mental limitations, and/or the like, and may be stored and/or analyzed by a system in accordance with embodiments of the present invention. In some embodiments, a first step in developing a support system for people with disabilities may comprise creation of an information profile of the person that can be easily shared with other people, government entities, and/or the like available or trying to support the person with disabilities. The system may be adapted to create a centralized, collaborative, and/or sharable profile that may comprise text data, pictures, audio, videos, real-time observational data, multimedia data, and/or the like.

In some embodiments of the present disclosure, a system may be adapted to assist in the long-term care of disabled persons, or the like. The system may be adapted to collect and monitor data related to activities, and the data may be collected and/or entered into the system by one or more parties in collaboration to form a collaborative profile for a disabled person, which may be stored on a server, or the like. For example, a parent or guardian of a disabled person may be provided or allowed to register for a “caregiver” user account for accessing the system and a medical professional may have a “healthcare provider” user account for accessing the system, wherein both the caregiver user account and the healthcare provider user account may enter data into the system regarding the behavior, skills, and/or the like of the disabled person. In some embodiments, behavior, skills, and/or the like of a dependent person may be observed at different times, described via data entered into the system, and associated with a user who recorded the data.

In some embodiments, the system may be adapted to perform an analysis and/or generate reports relating to a dependent person's behavior around certain individuals, groups of individuals, in certain locations, at certain times, after eating certain meals, and/or the like. In some embodiments, a system may indicate the relationship or correlation, if any, of the dependent person's behavior to a time period or being in the company of a specific individual, group of individuals, no individuals, and/or the like. For example, a dependent person may behave differently around their mother or father than they do around a medical professional. These behavioral traits and relationships may be recorded by one or more parties and/or users. As used herein, the terms “disabled” and “dependent” are generally used interchangeably.

In some embodiments, a system may be adapted to compile, display, transmit, and/or analyze a profile of a disabled person saved in the system. A user profile (i.e., a disabled person's profile) may be completed by various individuals and/or users and may comprise medical information, behavioral information, skills information about the user, personality traits, evaluation information, opinions regarding the user, the identity of the person entering the data, relationship data summarizing and/or describing interactions of various individuals with the user, guardianship information, responsible payee information, hygiene information (e.g., ability to shave, dress, bathe, use the bathroom, and/or the like), individual limitations of the user, financial and/or legal profiles, the user's income, the user's expenses, and/or the like. In some embodiments individuals may be provided access to the system via an Internet-based form, wherein the data received may be saved in a database of the system.

In some embodiments, the personal profile of a user may be shared with government agencies and workers such as state case managers, social workers, and/or the like. In some embodiments, the families of the user may be provided access to the system to enter all necessary information for the user. In some embodiments, the system may be integrated with a school database, for example, to notify the school about the skills, limitations, and/or the like that the user has without asking questions. In some embodiments, the system may be adapted to generate funding applications, for example, documents for applying for state funding and/or the like, which may be files stored on a computer or printed forms, or the like.

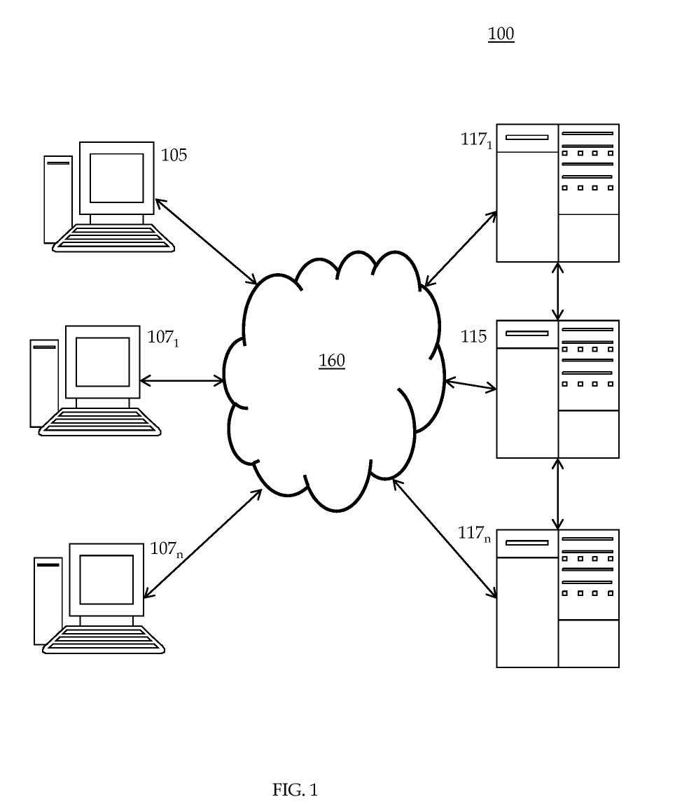

FIG. 1 depicts a system-level network diagram of a system 100 for generating a life plan in accordance with one embodiment of the present invention. The system 100 generally comprises at least a first client 105 and secondary clients 107₁ and 107₂, each in communication with an administrator, generally hosting a central server 115, through a network 160. Methods in accordance with one or more embodiments of the present invention take place over the network 160, which may comprise a global computer network, for example, the Internet.

Although FIG. 1 depicts two secondary clients 107₁ and 107n, it should be appreciated that “n” represents any number of clients feasible in accordance with embodiments of the present disclosure. For ease of reference, as used herein, the term “client” may refer to any one or all of the clients, 105, 107₁, and 107n within the system 100. Likewise, although FIG. 1 explicitly depicts only one first client 105, there may be more than one first client 105 in accordance with certain embodiments of the present invention. That is, in certain embodiments, multiple users may perform the same or similar functions as the first client 105. As understood by embodiments of the present invention, a user may include any person, social service, caregiver, healthcare provider, financial advisor, entity, or the like, capable of participating in the system and methods disclosed herein.

The first client 105 may generally comprise an entity or person with disabilities, or the like. In many embodiments, the first client 105 may be granted access to the system 100 to enter on his or her own behalf. For example, the first client 105 may communicatively couple to a server 115, or the like, and may transmit personal, behavioral, demographic, skills, or other data to the server 115, or the like. An exemplary first client 105 may comprise a device for accessing the system 100 by a person with developmental disabilities, mental illness, brain injuries, serious physical disabilities and seniors with disabilities, the families supporting the person, and/or the like. In some embodiments, a caregiver, parent, guardian, administrator, or the like may be provided access to the system to create a user account for a disabled person, or the like.

The secondary clients 107 may generally comprise support providers for the person, such as government programs, support companies, educational providers, counseling providers, healthcare providers, and/or the like. A support provider may generally comprise, for example, an entity or entities, a person, a group of people, granted access to the systems and methods of the present invention, or the like for purposes of providing support to one or more disabled persons. In many embodiments, the secondary clients 107 comprise the employees of a support provider for the first client 105, who are responsible for supporting the disabled person. The support provider entity may comprise anyone that comes into contact with, supports, teaches, counsels, guides, administers medical treatment to, or observes a disabled person. For example, a support provider may comprise a nurse, doctor, physical therapist, counselor, and/or the like that provide support services for a disabled person and observe his/or her skills and/or capabilities or the like.

In some embodiments, the first client 105, second client 107, and/or the like may be provided access to create a user profile for a disabled person and the system 100 may store the created profile. In some embodiments, the system may provide access to view, edit, delete, print, transmit, save, and/or the like data saved in the user profile. In some embodiments, the systems and methods of the present invention may comprise security settings, which may be configured by an administrator to limit access to edit, or the like, certain aspects of a common user profile, or the like. For example, a disabled person's parent may be provided access to edit his or her personal information (name, street, address, etc.) but may not be able provided access to edit his or her medical profile (medical histories, observations, and/or the like). In some embodiments all users will be provided access to edit a user's profile, but must identify the perspective or individual from which the data is received (e.g., parent, relative, friend, doctor, nurse, and/or the like). In some embodiments multiple parties may contemporaneously observe the same behavior and both parties may enter the system and confirm the observed behavior or the like. In some embodiments, when two or more parties or users confirm an observation of the same behavior and enter associated data into the system, the system may be adapted to provide an indication that the behavior has been confirmed by more than one party, to list the confirming parties, and/or to assign a higher weight to that associated data when generating a life plan for the disabled person, or the like.

The system 100 may be adapted to use a variety of assessments that may be conveniently organized into the life categories to speed access and ease of use. In some embodiments life categories may comprise, for example, Personal Character Strengths, Education, Personal Care and Awareness, Medical Conditions, Independent Living Skills, Vocational Skills, Family Financial Planning, Legal Planning, Community Supports, Personal Income and Expenses, Relationships, and/or Daily Routines, or the like. Providing a centralized, collaborative, and/or easily accessible profile for a disabled individual, may offer an excellent resource for training educators, therapists and care givers on how to properly care for the person with disabilities.

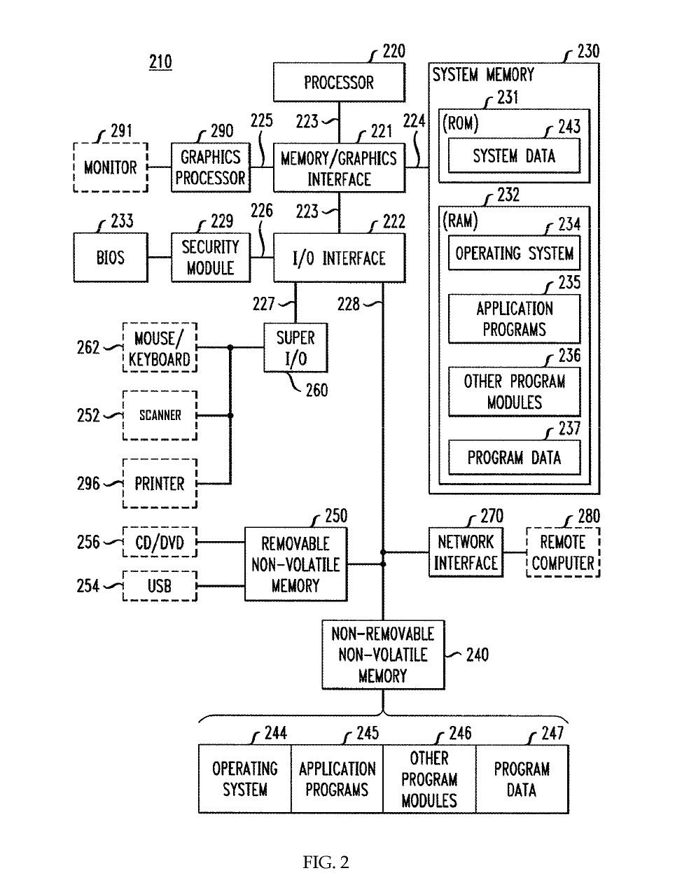

In a basic exemplary embodiment, within the system 100, the first client 105, and/or any of the secondary clients 107, may be capable of transmitting data to and from an administrator using a communication device. The communication device in the context of the present application may include, but is not limited to, a personal computer, a portable computer, a handheld computer, a netbook, a cellular phone, a smart phone, a mobile phone, a digital tablet, a laptop computer, tablet computer, a smart TV, a device configured to connect to the internet, an Internet appliance, an Apple iPhone, iPad, or iPod, an Android device, a Blackberry device, a Personal Data Assistant (PDA) or the like, or may generally include a general purpose computer, as discussed below with respect to FIG. 2.

The administrator generally comprises a server 115, which may further host an accessible data portal. In alternative embodiments, the server 115 may be located on a third party location (e.g., a server farm, cloud, or the like), or at a location of the first client 105, or any one or more of the secondary clients 107. The accessible data portal, which may be accessible to the first client 105 and any of the secondary clients 107, may communicate with each user through the network 160. The accessible data portal may comprise any number of security measures to provide a reasonably secure system, suitable for embodiments of the present invention. The accessible data portal may further comprise a graphical user interface (GUI) through which any of the first client 105 or secondary clients 107 may access the server 115.

Methods in accordance with embodiments of the present invention may take place over the network 160, which may comprise a global computer network, for example, the internet. The communications functions described herein can be accomplished using any kind of wired and/or wireless computing network or communications means capable of transmitting data or signals, such as a wireless and/or wired computing network allowing communication via, for example, an 802.11 wireless LAN (“WLAN”) protocols, “Wi-Fi” protocols, Bluetooh protocols, 60 Ghz Protocols (“WirlessHD” and “WiGig”), Wireless Home Automation protocols (“Z-Wave” and “Zigbee”), cellular data protocol (e.g., EDGE, CDMA, CDMA2000, TD-SCDMA, WCDMA, UMTS, HSDPA, EVDO, TDMA, FDMA, GSM, LTE, HSPA+, WiMAX, OFDMA), and/or the like. Suitable examples include a packet-switched network, a local area network (LAN), wide area network (WAN), virtual private network (VPN), or any other means of transferring data. The network 160 may be a partial or full deployment of most any communication/computer network or link, including any of, any multiple of, any combination of or any combination of multiples of a public or private, terrestrial wireless or satellite, and wireline networks or links. A single network 160 or multiple networks (not shown) that are communicatively coupled to one another can be used. It is contemplated that multiple networks of varying types can be connected together and utilized to facilitate the communications contemplated by the systems and elements described in this disclosure.

As used herein, the term “computer” may generally refer to any device that is capable of processing a signal or other information. Examples of computers include, without limitation, a personal computer, a portable computer, a handheld computer, a cellular phone, a smart phone, a digital tablet, a laptop computer, a netbook, a smart TV, a device configured to connect to the internet, an Internet appliance, a Personal Data Assistant (PDA), an application-specific integrated circuit (ASIC), a programmable logic array (PLA), a microcontroller, a digital logic controller, a digital signal processor (DSP), or the like, or may generally include a general purpose computer, as discussed below with respect to FIG. 2. A computer may include software in the form of programmable code, micro code, and or firmware or other hardware embedded logic and may include multiple processors which operate in parallel. The processing performed by a computer may be distributed among multiple separate devices, and the term computer encompasses all such devices when configured to perform in accordance with the disclosed embodiments.

The client 105 may generally comprise a communications device, such as a computer. In a basic exemplary embodiment, within the system 100, the client 105 may be capable of transmitting data to and from a host server 115. The host server 115 may host an accessible data portal (e.g., a website or the like). The accessible data portal, which may be accessible to the client 105, may communicate with the client 105 through the network 160. The accessible data portal may comprise any number of security measures to provide a reasonably secure system, suitable for embodiments of the present disclosure. The accessible data portal may further comprise a graphical client interface (GUI) through which a client 105 may access the server 115.

The system may also comprise secondary servers 117₁ and 117ₙ. Although two secondary servers 117₁ and 117ₙ are depicted in FIG. 1, it should be appreciated that “n” represents any number of servers feasible in accordance with embodiments of the present disclosure. For ease of reference, as used herein, the term “server” may refer to any one or all of the servers, 115, 117₁, and 117ₙ within the system 100. That is, in certain embodiments, multiple servers may perform the same or similar functions.

The server 115 may also comprise one or more databases or other sortable data storage memory to enable the system and methods disclosed herein. In many embodiments, the database may be any commercially available data storage database suitable for embodiments of the present disclosure. For example, in one embodiment, the database comprises at least one or more database management systems, such as any of an Oracle, DB2, Microsoft Access, Microsoft SQL Server, Postgres, MySQL, 4th Dimension, FileMaker, Alpha Five Database Management System, or the like. Often contained within the database is a plurality of data sets, each comprising specific data. A first data set may correlate to a first client 105, wherein a plurality of client-specific data is stored. The database may also include any number of subsequent data sets representing N clients, wherein N represents any number of clients practical for operation of embodiments of the present disclosure. In accordance with one embodiment of the present disclosure, any of the servers or clients may comprise a general purpose computer, for example, as shown in the form of a computer 210 depicted in FIG. 2.

In accordance with one embodiment of the present invention, any of the administrator or users may comprise a general purpose computer, for example, as shown in the form of a computer 210 depicted in FIG. 2. As appreciated by embodiments of the present invention, more practical devices, such as mobile devices, mobile telephones, or the like, are likely to be utilized than a general computer 210 for embodiments of the present invention. However, it is also appreciated there is a significant similarity in core components between a mobile device and a general computer 210. The following components are described for exemplary purposes only, and each component's mobile equivalent is also contemplated within embodiments of the present invention.

FIG. 2 depicts a block diagram of a general computer system, which is capable of being used in connection with the system depicted in FIG. 1, in accordance with embodiments of the present disclosure. As appreciated by embodiments of the present disclosure, mobile devices, such as mobile telephones, tablets, netbooks, or the like, may be utilized instead a general computer 210 for embodiments of the present disclosure. However, it is also appreciated there is a significant similarity in core components between a mobile device and a general computer 210. The following components are described for exemplary purposes only, and each component's mobile equivalent is also contemplated within embodiments of the present disclosure.

Components shown in dashed outline are not part of the computer 210, but are used to illustrate the exemplary embodiment of FIG. 2. Components of computer 210 may include, but are not limited to, a processor 220, a system memory 230, a memory/graphics interface 221, also known as a Northbridge chip, and an I/O interface 222, also known as a Southbridge chip, or the like. The system memory 230 and a graphics processor 290 may be coupled to the memory/graphics interface 221. A monitor 291 or other graphic output device may be coupled to the graphics processor 290.

A series of system busses may couple various system components including a high speed system bus 223 between the processor 220, the memory/graphics interface 221 and the I/O interface 222, a front-side bus 224 between the memory/graphics interface 221 and the system memory 230, and an advanced graphics processing (AGP) bus 225 between the memory/graphics interface 221 and the graphics processor 290. The system bus 223 may be any of several types of bus structures including, by way of example, and not limitation, such architectures include Industry Standard Architecture (ISA) bus, Micro Channel Architecture (MCA) bus and Enhanced ISA (EISA) bus. As system architectures evolve, other bus architectures and chip sets may be used but often generally follow this pattern. For example, companies such as Intel and AMD support the Intel Hub Architecture (IHA) and the Hypertransport architecture, respectively.

The computer 210 typically includes a variety of computer readable media. Computer readable media can be any available media that can be accessed by computer 210 and includes both volatile and nonvolatile media, removable and non-removable media. By way of example, and not limitation, computer readable media may comprise computer storage media and communication media. Computer storage media includes volatile, nonvolatile, removable, and/or non-removable media implemented in any method or technology for storage of information such as computer readable instructions, data structures, program modules or other data. Computer storage media includes, but is not limited to, RAM, ROM, EPROM, flash memory or other memory technology, CD-ROM, digital versatile disks (DVD), blue-ray or other optical disk storage, magnetic cassettes, magnetic tape, magnetic disk storage or other magnetic storage devices, or any other medium which can be used to store the desired information and which can be accessed by computer 210. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 230 includes computer storage media in the form of volatile and/or nonvolatile memory such as read only memory (ROM) 231 and random access memory (RAM) 232. The system ROM 231 may contain permanent system data 243, such as identification information. In some embodiments, a basic input/output system (BIOS) may also be stored in system ROM 231. RAM 232 typically contains data and/or program modules that are immediately accessible to and/or presently being operated on by processor 220. By way of example, and not limitation, FIG. 2 illustrates operating system 234, application programs 235, other program modules 236, and program data 237.

The I/O interface 222 may couple the system bus 223 with a number of other busses 226, 227 and 228 that couple a variety of internal and external devices to the computer 210. A serial peripheral interface (SPI) bus 226 may connect to a basic input/output system (BIOS) memory 233 containing the basic routines that help to transfer information between elements within computer 210, such as during start-up. In some embodiments, a security module 229 may be incorporated to manage metering, billing, and enforcement of policies. The security module 229 may comprise any security technology suitable for embodiments disclosed herein.

A super input/output chip 260, or the like, may be used to connect to a number of peripherals, such as a scanner 252, keyboard/mouse 262, and printer 296, as examples. The super I/O chip 260 may be connected to the I/O interface 222 with a low pin count (LPC) bus, in some embodiments. The super I/O chip 260 is widely available in the commercial marketplace. In one embodiment, bus 228 may be a Peripheral Component Interconnect (PCI) bus, or a variation thereof, may be used to connect higher speed peripherals to the I/O interface 222. A PCI bus may also be known as a Mezzanine bus. Variations of the PCI bus include the Peripheral Component Interconnect-Express (PCI-E) and the Peripheral Component Interconnect-Extended (PCI-X) busses, the former having a serial interface and the latter being a backward compatible parallel interface. In other embodiments, bus 228 may be an advanced technology attachment (ATA) bus, in the form of a serial ATA bus (SATA) or parallel ATA (PATA).

The computer 210 may also include other removable/non-removable, volatile/nonvolatile computer storage media. By way of example only, FIG. 2 illustrates a hard disk drive 240 that reads from or writes to non-removable, nonvolatile magnetic media. Removable media, such as a universal serial bus (USB) memory 254 or CD/DVD drive 256 may be connected to the PCI bus 228 directly or through an interface 250. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

The drives and their associated computer storage media discussed above and illustrated in FIG. 2, provide storage of computer readable instructions, data structures, program modules and other data for the computer 210. In FIG. 2, for example, hard disk drive 240 is illustrated as storing operating system 244, application programs 245, other program modules 246, and program data 247. Note that these components can either be the same as or different from operating system 234, application programs 235, other program modules 236, and program data 237. Operating system 244, application programs 245, other program modules 246, and program data 247 are given different numbers here to illustrate that, at a minimum, they are different copies. A client may enter commands and information into the computer 210 through input devices such as a mouse/keyboard 262 or other input device combination. Other input devices (not shown) may include a microphone, joystick, game pad, satellite dish, scanner, or the like. These and other input devices are often connected to the processor 220 through one of the I/O interface busses, such as the SPI 226, the LPC 227, or the PCI 228, but other busses may be used. In some embodiments, other devices may be coupled to parallel ports, infrared interfaces, game ports, and the like (not depicted), via the super I/O chip 260.

The computer 210 may operate in a networked environment using logical connections to one or more remote computers, such as a remote computer 280 via a network interface controller (NIC) 270. The remote computer 280 may be a personal computer, a server, a router, a network PC, a peer device or other common network node, and typically includes many or all of the elements described above relative to the computer 210. The logical connection between the NIC 270 and the remote computer 280 depicted in FIG. 2 may include a local area network (LAN), a wide area network (WAN), or both, but may also include other networks. Such networking environments are commonplace in offices, enterprise-wide computer networks, intranets, and the Internet. In some embodiments, the network interface may use a modem (not depicted) when a broadband connection is not available or is not used. It will be appreciated that the network connection shown is exemplary and other means of establishing a communications link between the computers may be used.

Although the computer 210 of FIG. 2 is described as an exemplary computing device for various applications of embodiments of the present invention, it should be appreciated, a multitude of similar computing devices exist and are equally suitable for embodiments of the present disclosure. It is further understood by embodiments of the present disclosure, a computing device may comprise all of the elements disclosed in FIG. 2, or any combination of one or more of such elements, in order to perform the necessary functions of the embodiments of the present disclosure. It is understood by embodiments of the present disclosure that a computer, such as the one depicted in FIG. 2, may be connected to a computer network or system. A computer network may include the Internet, a global computer network, an internal computer network, dedicated server networks, or the like.

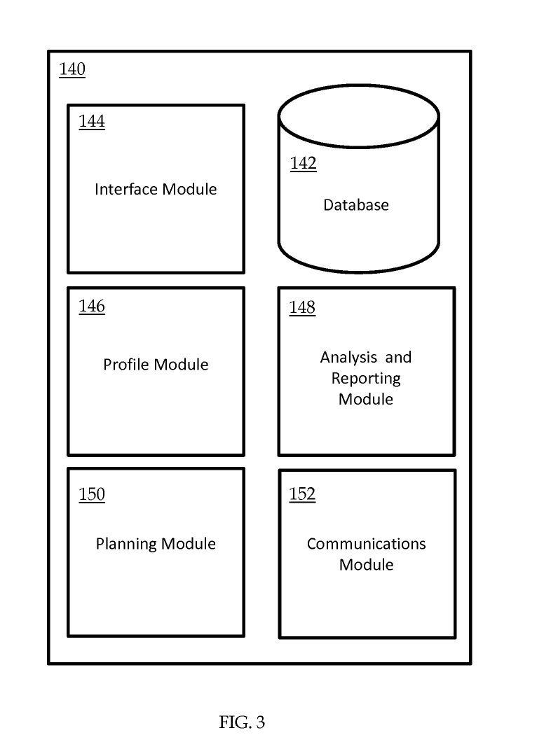

FIG. 3 depicts a block diagram illustrating a system 140 for generating a life plan in accordance with embodiments of the present invention. The system for generating a life plan 140 may generally comprise computer executable software and/or instructions configured to perform the functionality of the systems and methods disclosed herein. The system for generating a life plan 140 may be stored on a server, on a local computing device, on a mobile communications device, and/or the like. The system 140 may comprise a database 142, an interface module 144, a profile module 146, an analysis and reporting module 148, a planning module 150, a communications module 152, and/or the like. In accordance with exemplary embodiments of the present invention, any module may be merged and/or combined with any other module. In some embodiments, additional or fewer modules than those depicted in FIG. 3 may be included.

In exemplary embodiments, the system 140 for generating a life plan may be configured to allow registration of a user account for a disabled person, or the like, receive, store, and analyze data related to the disabled person, and generate a life plan, or the like, for a disabled person. The system 140 may be adapted to receive data and create a common collaborative profile accessible by more than one user account and/or outside systems. For example, a disabled person's caretaker, healthcare provider, social worker, and/or other parties that interact with the disabled person may have access to the disabled person's common profile and may be provided access to view, edit, and/or delete certain portions of the profile, dependent upon the permissions assigned to each user's account by an administrator, or the like.

In some embodiments, the system 140 may be adapted to allow multiple user account to be issued, wherein the multiple user accounts have varying levels of security access and permissions to view, edit, and/or delete certain selected portions of a disabled person's common collaborative profile. In exemplary embodiments, the term “user” may generally refer to any party provided with access to the systems and methods in accordance with embodiments of the present invention. For example, a user may comprise a disabled person, a social worker, a healthcare provider, a family member, a friend, a caretaker, a counselor, a doctor, a nurse, a physical therapist, a personal trainer, a nutritionist, a person who observes or otherwise has knowledge of the disabled person's behavior and/or skills, an insurance company employee, a financial advisor, an academic advisor, a life coach, and/or the like.

In exemplary embodiments, the system 140 may comprise a computer-implemented system and method for generating a life plan via a global-computer network. In one embodiment of the present invention, such systems and methods may be embodied in software comprising a web and/or downloadable mobile application. In exemplary embodiments, the system 140 may comprise executable instructions and/or software that allows multiple parties to enter data regarding a disabled person and generates a life plan based on the data received by the combination of all multiple parties.

In some embodiments, a disabled user or any other party may be required to register and obtain a user account, or the like, to access the system 140. In some embodiments, the system 140 may comprise a web application, or the like. A web application may comprise a set of instructions executable by a computer, a computer application, and/or software accessible via a network, e.g., the Internet. In some embodiments, the web application may be configured for use with a computer configured to perform the methods presented herein. In some embodiments, a web application may be configured to receive user account requests from caretakers, healthcare providers, counselors, or the like, and create user accounts for the disabled user, or the like.

In exemplary embodiments, the interface module 144 may be adapted to provide the user with a means for interacting with the system 140 for generating a life plan. The interface module 144 may be adapted to present a graphical user interface (GUI) to the user, the GUI adapted to allow users to input, view, and interact with the system 140. In some embodiments, the interface module 144 may be adapted to allow entering data regarding a disabled person, viewing data relating to the disabled person, generating reports relating to the disabled person, generating a life plan, sharing a common profile for the disabled person with a third party such as a government agency an insurance company, or the like, performing any of the functions described herein, and/or the like

In some embodiments, the interface module 144 may be displayed to a user via a display on a computer, a tablet, a mobile device, a laptop, a touchscreen device, and/or the like. The interface module 144 may also be adapted to provide an opportunity to register a user account for accessing the system 140. User accounts may be restricted to authorized users and a verification of a user's identity, such as a social security number or a unique identifier, may be required. In some embodiments, user account requests must be approved by an administrator of the system 140 and/or may only be created by an administrator. The interface module 144 may be adapted to allow a user to run a search query on data stored in the database 142.

In accordance with exemplary embodiments of the present invention, the interface module 144 may also allow a user to access data related to a disabled person that was generated, filtered, and/or stored by the analysis and reporting module 148. The interface module 144 may be adapted to allow the user to run a report on the data contained in the database 142 with the analysis and reporting module 148 upon request, at predetermined intervals, or upon the occurrence of an event. For example, a user may access data regarding a specific disabled person, a group of disabled persons, their life plans, and/or the like, upon running a report request with the interface module 144. The interface module 144 may also be adapted to transmit and/or display alert messages to a user when changes are made within the system 140, when action is required by the user, and/or the like.

In exemplary embodiments, alerts may be presented to the user via a display on a computer or electronic device, via a text or SMS message, via an automated phone call, via email, via an auto-generated letter via postal mail. When an alert is generated, it may be sent to multiple parties. For example, if the analysis and reporting module 148 generates an alert, for example, upon modification of a user's life plan, multiple users, groups of users, or businesses may be notified. The interface module 144 may also be adapted to allow users who are granted sufficient permissions by the administrator to add, delete, and/or modify data saved in the system. Certain data may be completely restricted from modification or deletion, however, such as data entered by an administrator or healthcare provider. The interface module 144 may also be customized by a user and/or an administrator. For example, the interface module 144 may be customized to display data relating to a disabled person and/or the like in a customized visual format. The interface module 144 may also be customized to display system data at certain time intervals, upon the occurrence of an event (e.g., creation of a new user account), or upon request of a user and/or administrator. In exemplary embodiments the system 140 may be adapted to allow users to effectively access government services and to supplement these services with family resources requires knowledge and planning, or the like.

The system 140 may be adapted to generate a life plan that may comprise eight important lifetime planning areas that people with disabilities and their families need to address: care planning, education planning, transition planning, employment planning, accessing government services, family financial planning, family legal planning, future housing planning, or the like. Each lifetime planning area may be presented in a single plan and/or separate individual plans. In some embodiments the system may be adapted to generate recommendations in one or more of the lifetime planning areas based on data received about a disabled person, or the like.

In some embodiments, the system 140 may be adapted to provide care planning. Care planning may generally comprise providing access to, and/or data relating to access to, necessary health, safety and/or behavioral supports to properly care for a person with disabilities. Education planning may generally comprise providing access to programs relating to, and/or data relating to access to, ensuring the person with disabilities receives the free and appropriate education in the least restrictive environment that they are able to under the applicable law. For example, the system may be adapted to allow a student with disabilities an interface for finding a college or educational institution that effectively supports students with disabilities. For example, the system may generate a grade or score for each educational institution based on the available support programs for users with a specified disability, and/or feedback received from individuals with knowledge of the effectiveness of the educational institution in supporting students with disabilities, or the like.

In some embodiments, transition planning may generally comprise preparing disabled students for high school, or the like, graduation and providing guidance to the student to ensure a smooth transition for the student between a high school and the post school social service system, a smooth transition to college, and/or the like. In some embodiments, employment or day activity planning may generally comprise planning to assist students interested in employment in securing a job after high school or some productive day activity, or the like.

In some embodiments, accessing government services may generally comprise allowing a student to apply and/or guiding a disabled student through the application process to obtain certain government benefits. For example, the system 140 may be adapted to provide an interface for a disabled person to apply for Social Security benefits or SSI, Medicaid, the services of the Division of Developmental Disabilities (DDD), the Division of Vocational Rehabilitation (DVRS), and/or other government services and agencies serving people with disabilities. In some embodiments, the system 140 may be adapted to perform an assessment of a disabled person's user profile and match the user with programs in which he or she is likely to receive support based on eligibility criteria. In some embodiments, the system 140 may be adapted to provide real-time eligibility data and may update the assessments in real-time when eligibility criteria are changed.

In some embodiments, family financial planning may generally comprise providing a budget, retirement plan, financial support plan for supporting disabled individuals for their entire life, and/or the like. As the general population ages, government entities can be under tremendous pressure to do more with less revenue. That is why it may be absolutely critical families begin to save and fund for the future support needs of their family member with a disability. The system 140 may be adapted to provide financial planning not only for the disabled individual, but for the family members or caregivers responsible for the wellbeing of the disabled individual, or the like as well. If a person's disability prevents the person from earning an income, it is even more critical that this financial planning support is provided to family members, or the like, to ensure the long-term well-being of the disabled person.

In some embodiments, the system 140 may be adapted to provide financial planning advice to a family member, or the like based on data related to the resources, income, assets, net worth, income, and/or the like of the family member and the past, current, and projected financial needs of the disabled individual. Whether it is earmarking funds for future housing needs, or the recreational needs of the relative with a disability, families need to begin saving as early as possible and the system 140 may be adapted to provide these families with guidance for financial planning. In some embodiments, the system 140 may be adapted to provide a disabled individual's family with a step-by-step plan in saving the appropriate amount of money allocating the proper amount of funds for the disabled individual's long-term wellbeing.

In some embodiments, the system 140 may be adapted to provide family legal planning. Family legal planning may comprise guidance on applying for guardianship over the person with disabilities, properly structuring their will, setting up a special needs trust to provide supplemental funding for the person with disabilities, and/or the like. In some embodiments the system may evaluate data in the disabled individual's user profile in conjunction with data associated with the disabled individual's family and/or caregivers to determine the correct legal plan to follow. In some embodiments, the system 140 may provide direct access to a legal professional when further information is required by the system and/or by a user. Direct access to a legal professional may comprise video, audio, and/or text chat between a user and the legal professional, and/or the like.

In some embodiments, the system 140 may be adapted to provide future house planning. There is a significant low income housing shortage in certain parts of the country and the world. For example, in the state of New Jersey in the United States there is a significant housing shortage. Government vouchers, such as section 8 vouchers, or the like, are often unavailable, and waiting lists for some government programs may last over a decade. The system 140 may be adapted to project housing costs and provide a saving plan for families of disabled individuals, or the like, so they can potentially purchase a home for the disabled individual in the future and monitor the individual's transition into independent living.

In accordance with exemplary embodiments of the present invention, a profile module 146 may be adapted to create, edit, store, transmit, access, and/or the a profile for a disabled individual. The profile for a disabled individual may be referred to herein as a “profile”. A “profile” may comprise data associated with a disabled individual. In some embodiments, a profile module 146 may be adapted to receive data for storing in the database 142, the data associated with an individual's profile, via one or more sources. For example, the profile module 146 may be adapted to receive data for an individual's profile via a single user account or multiple user accounts.

In some embodiments, access to different portions of a disabled individual's profile may be restricted to certain users by the profile module 146, which may be selected and/or configured by an administrator, the disabled individual, and/or the like. For example, a first user may be granted access to the profile module 146 to enter and edit personal contact details for a disabled individual saved in a profile and a second user may not be granted access to enter or edit the personal contact details. The second user may be granted access to enter and edit data related to the social skills of a disabled individual for a particular profile and the first user may not be granted access to enter or edit data related to the social skills of the disabled individual, or the like. Generally, security permissions and/or access to certain areas of a profile may be granted and/or restricted by an administrator. In some embodiments, each user account may comprise an account type with associated default security permissions and access to the profile via the profile module 146. For example, account types may comprise a main user, an administrator, a caregiver, a healthcare provider, a financial advisor, a social worker, a counselor, and/or the like. Each of the account types may comprise a different level of access and/or security permissions to access portions of one or more profiles via the profile module 146. Alternatively, in some embodiments each user account may be provided with the same security permissions and/or access and or each user account may be configured by an administrator at the time of a request received for a user account, or the like.

In some embodiments, the system 140 may comprise an internet based, security protected, web and print based information system that produces a comprehensive multi-media profile (i.e. the profile) of a person with disabilities. The profile module 146 may be adapted to receive data for creation of a profile from a user, another system, a scanned form, and/or the like. A profile may comprise a set of very detailed, yet easy to complete assessments of the person with disabilities. In some embodiments, these assessments may be conveniently located organized in life categories v the profile module 146 to speed access and ease of use. Some examples of life categories may comprise: Personal Character Strengths, Education, Personal Care and Awareness, Medical Conditions, Independent Living Skills, Vocational Skills, Family Financial and Legal Planning, Community Supports, Income and Expenses, Relationships, and Daily Routines.

The system 140 may also be adapted to access videos that show or instruct a user on how to provide proper personal care, deal with behavior issues, other life skills, and/or the like. In addition, the system 140 may be adapted to store relevant support plans used by government programs or other entities that provide support to people with disabilities. For example, the system 140 may be adapted to access the education system's individualized education programs (IEP's), and/or various post-school government agencies (Developmental Disabilities, Mental Illness, Vocational Rehabilitation, etc.) that provide support to people with disabilities.

In some embodiments, while the system 140 may be easily accessible via the internet, or the like, the system 140 may be adapted to print copies of all data and reports and/or receive hand-written reports, scan the reports, recognize the text written on the reports via an optical character recognition module, parse, sort, and store data in a profile in the appropriate section, or the like. In some embodiments, the system may make use of various paper forms printed with an identifier, such as a bar code, QR code, and/or have an embedded RFID chip for identifying the document or the type of document.

In some embodiments, the system may recognize a type of form by scanning a bar code, inputting a form code, and/or the like. After the form type is recognized or input into the system, the system may then be able to scan, read, and store the data on the form in the appropriate portions of a user's profile. In some embodiments, a set of data entered on forms may mirror the data input into the system. In some embodiments, the system 140 may be adapted to provide manuals to a disabled individual, a family member, a caregiver, a guardian, a healthcare provider, a counselor, and/or the like. For example, the system 140 may be adapted to provide a profile/caregiver manual and/or a life plan/guardian manual. In some embodiments, the system 140 may be adapted to provide two main functions: (1) to store and allow access to a profile for a disabled individual and (2) to generate a life plan based on the data in a user's profile.

In some embodiments, the system 140 may be adapted to generate a caregiver manual for access by a caregiver for a disabled person. A caregiver manual may comprise an indexed reference that is organized into life categories: Personal Character, Education, Personal Care and Awareness, Medical Conditions, Independent Living skills, Vocational Skills, Family Financial and Legal Planning, Community supports, Income and Expenses, Relationships and Daily Routines. In some embodiments, the system 140 may be adapted to print the manual in separate sections for inclusion in a binder, or the like. While the complete profile is an extensive document the system 140 may be adapted to provide an abbreviated document, which may be referred to as an essential profile, which may comprise summary documents of the various sections. The abbreviated document may allow the person with disabilities, their parents/guardians, or support organizations to easily share the critical care highlights of supporting the person with disabilities. The abbreviated document may comprise a report in digital/stored data and/or print form.

In some embodiments, the system 140 may be adapted to generate and/or display a guardian manual. A guardian manual may comprise the complete profile of a disabled individual and additional sections comprising family legal and financial planning documents (e.g., wills, special needs trusts, guardianship papers, or the like), medical records, important personal documents (e.g., copies of birth certificate, social security card, state issued identification cards, or the like), and government agency support plans (e.g., Developmental Disabilities, Vocations Rehabilitation, or the like.), documents relating to a life plan for the disabled individual, and/or the like. In some embodiments, the guardian manual may comprise only the additional sections. The guardian manual may provide guidance to a guardian of a disabled individual for the wellbeing of the disabled individual.

In some embodiments, a life plan may be generated by the system 140. A life plan may comprise many or all of the same components of the guardian manual but be directed to a disabled individual who does not require guardianship. The guardian manual and/or life plan may be generated by the system 140 and/or the planning module 150 and may be adapted to provide, in one location, all the important information pertaining to the person with disabilities, or the like.

In exemplary embodiments, the system may provide an easily usable interface via the interface module 144. The system 140 may be adapted to store and provide documents (e.g., a profile, a caregiver manual, a guardian manual, a life plan, or the like) that are stored in secure and/or security protected web-based relational database that may be organized by life category. The documents stored by the system 140 may be easily accessible and updateable via the interface module 144. In some embodiments, a last updated field may be displayed by the interface module 144 via the system 140 that may indicate when an assessment, a profile, a plan, and/or the like were last updated. The system 140 may be adapted to generate and provide (e.g., display, print, transmit, or the like) summary information pages, including a Likes and Dislikes Summary, Medical Condition & Awareness Summary, Vocational Summary and/or the like. Summary information pages may generally be adapted to provide, via the system 140, the results of detailed assessments, and/or the like, thereby eliminating some double work, such as retyping data.

While the system 140 may generate and provide life plan documents comprising multiple assessments, not all assessments may be appropriate for every person. Young children, for example, may not need an assessment of their Independent Living, Vocational Skills, or the like. However, these assessments may be appropriate for a High School student ready to graduate. The system 140 may comprise flexible design options adapted to allow profile creators to pick and choose the profile design that is best for them. In some embodiments, profile structures can be modified and changed as circumstances evolve over time.

In some embodiments, the system 140 may be adapted to allow profile creators, administrators, or the like to control online access to one or more profiles. In some embodiments, only users authorized by the profile creator can access a profile system. In addition, profile creators may be provided the ability control what type of access users have via the system 140. Some users may be able to view and edit a profile while other people may have view only access. This feature may empower profile creators, whether the person with disabilities, parents/guardians, state agencies, or care giving organizations, or the like with the ability to modify data in a profile and customize a life plan, a guardian manual, a caregiver manual, and/or the like. In some embodiments, profile and/or plan information access may be restricted and may only be shared with users that creators authorize.

The system 140 may be adapted to provide information, via the profile and/or any number of plans or manuals generated by the system 140 that emphasizes the strengths of a person with disabilities, in addition to their support needs. The system 140 may be adapted to allow parents/guardians/caregivers, or the like, to create the profile for a disabled person at a young age, to update the profile over time, and to share the information with the people supporting the disabled person over the course of their life. The system 140 may provide a level of assurance that the parent's perspective is not lost even if responsibility for caregiving may transfer to others over time.

In exemplary embodiments, a common information platform provided by the system 140 may provide consistency and uniformity in information-based decision making regardless of the venue (home, school, work or in the community). The online and/or printed manuals provided by the system 140, along with family financial and legal plans, or the like, are documents that have retain value during the entire lifetimes of the parents/guardians of the person with disabilities. Future care givers, whether guardians or organizations will also be provided access to the system 140 to update the information system and manuals as needed so they can remain current and accurate.

In some embodiments, creating a profile with the profile module 146, or the like, may comprise providing assessments to a user, such as a disabled individual or a guardian of a disabled individual. The assessments themselves may become an important tool in organizing, thereby allowing guardians, or the like, to effectively plan for the future for their loved one. Sections on family financial and legal planning, independent living skills, and vocational skills provided by the profile module 146 may ask probing questions that parents/guardians can address to help guide them in creating as independent life as possible for the person with disabilities.

In accordance with exemplary embodiments of the present invention, the analysis and reporting module 148 may be adapted to analyze data collected by the system. The analysis and reporting module 148 may be adapted to generate repots relating to an individual disabled person's profile, life plan, manual, or the like. In some embodiments, the system 140 may be adapted to provide customized reports summarizing data for all users in a geographic location, such as a state, county, city, and/or the like. In some embodiments, the system 140 may be adapted to provide comparisons of the support provided in different locations and/or for different types of disabilities and/or the like. In some embodiments, the analysis and reporting module 148 may be adapted to provide the data analysis and report generation required by the system 140. In some embodiments, the analysis and reporting module 148 may be provided with access to all data stored by the database 142, or the like, and may be adapted to manipulate and or generate reports on the data in accordance to instructions form a user and/or configurations set by an administrator, or the like.

In exemplary embodiments, the planning module 150 may be configured to provide a life plan, a guardian manual, and/or the like. The planning module 150 may generate a virtual blueprint for an disabled individual that does not require a guardian and/or a guardian/caregiver of a disabled individual that requires guardianship for at least a portion of the remainder of his/or her life. The planning module 150 may be adapted to provide an online and/or printed profile, life plan, and/or abbreviated essential life plan to a user, both of which are excellent tools to train future guardians, teachers, aids and staff on who the person with disabilities is (via the profile) and how best to support them (via the plan).

The planning module 150 may generally provide an organizational tool for users when applying for government services (e.g., social services, or the like). Many families are not prepared for the confusing eligibility based world of social services. The more organized and informed a family is the more effectively they can advocate for the services and supports they need. Accordingly, the planning module 150 may be adapted to provide a plan for a disabled user. The plan for a disabled user may be an excellent tool to have when completing applications for social services, or the like.

In some embodiments, the system 140 may provide a justification for legal claims, insurance claims, and/or the like. The planning module 150 may be adapted to provide a plan or module and/or a budget that may provide a justification for legal claims involving personal injury litigation and/or divorce related child support. The plan, manual, and/or budget can provide a court, or the like, an excellent visual history of how the disability affects the person with a disability. In addition, by defining the costs of care through a line item budget via the system 140, attorneys may be able to justify lump sum settlements to cover the cost of care over the lifetime of the person.

A system 140 in accordance with embodiments of the present disclosure plan may be adapted to provide an information system to a guardian or caregiver for the person they support. In many legal jurisdictions, at age 18 (known as the Age of Majority), legal rights previously given to parents or guardians may transfer to the person. These may include the right to: consent to medical treatment, determine living arrangements, sign contracts, and make financial and education decisions. In some instances, a person with significant disabilities may be unable to govern themselves or manage their affairs even after the age of 18. The legal process, known as Guardianship, allows the courts to determine “incapacitation” of the person and appoint a Guardian who will be responsible for making all or some of the life decisions for the person. The system 140 may be adapted to receive, store, analyze, manipulate, transmit, display, and/or otherwise provide data that may make guardianship process easier, such as assessments of the incapacitation of the person.

While most individuals have to deal with transitions in life, transition planning as used herein refers to the process of insuring that students with disabilities effectively transition to a productive and fulfilling post school life. Some students with disabilities may attend college, other students may choose to work, while others may need some type supported day activity. Often students with disabilities need ongoing and lifelong support to effectively transition to post school life. Unfortunately the rights based system of public education is often entirely different from the eligibility based world of the social service system. Students with disabilities do not automatically receive services from the social service system when they graduate. Students must apply and be found eligible for social service supports. In addition, some supports, such as, social security have employment income limitations that, if exceeded, could jeopardize the person with disabilities social security benefit and access to important state services, such as, Medicaid and Medicaid funded programs and services. A system 140 in accordance with exemplary embodiments may be adapted to provide guidance and essential data to effectively manage transition planning for a disabled student, or the like.

There currently exists a variety of government and government sponsored social service agencies that provide post school services to people with disabilities. A system 140 in accordance with embodiments of the present disclosure may be adapted to assist families in securing the services that their loved one is eligible for. In some embodiments, the system 140 may be adapted to assist parents in completing a pro se application to secure full or limited guardianship over the person with disabilities, or the like. The system 140 may be adapted to provide people with developmental disabilities with line item budgets that use state funding, personal income (e.g., employment, social security, or the like), and family assets to create the necessary resources to live as independent as life, as possible. The system 140 may be adapted to create a family financial plan to provide supplemental funding, (e.g., a Special Needs Trust, or the like), for a family member with a disability.

The system 140 may be adapted to take into consideration the limitations of future state and federal funding support when developing a family financial plan that will provide supplemental support for a person with a disability. As with any savings or insurance programs, the earlier families begin the accumulation process the more time they have to use the benefits of compounded interest to accumulate the resources they need. The system 140 may be adapted to provide financial projections based on current and projected interest rates and rates of return that may be updated in real-time or at various times selected by an administrator, or the like. The system 140 may be adapted to alert families that they must save for the future support needs of their family member with disabilities, and may automate the process by coordinating with an employer and/or a banking institution to automatically deduct a specified amount from one or more family member's paychecks and/or bank account at predetermined times.

In some embodiments the system 140 may be adapted to provide access to attorneys that specialize in special needs planning, or the like. These attorneys may utilize the system 140 to prepare wills and other legal documents for a disabled person. In some embodiments, the system 140 may provide the ability to create, monitor, and maintain a special needs trust, or the like. A special needs trust, or the like may provide future care providers the maximum supplemental financial assistance to support the special person while not jeopardizing government programs. The system 140 may be adapted to allow a user, who may be an attorney a special needs person as the income beneficiary.

In order to set up a trust via the system 140, the system 140 may be adapted to require authentication of the users credential, for example, a bar admission identification number or the like. After the trust or the like is created, the system may monitor the trust and ensure the disabled person receives funds at the appropriate times in accordance with a plan generated by the planning module 150. The system 140 may be adapted to ensure the disabled person receives the appropriate funds for supplementary needs. The system 140 may also be adapted to indicate who will receive any remaining trust assets when the special person dies. The system 140 may also be adapted to receive changes in the law and dynamically adjust the plans and/or the trust based on the current law in real-time, or the like.

In some embodiments, the system 140 may be adapted to present various checkpoints to the user related to goals the system has generated for the user. The user must then verify that they have completed the various checkpoints by transmitting or entering a confirmation. When the system 140 receives a confirmation, a next available checkpoint or goal may be presented to the user. If the system 140 does not receive a confirmation within a predetermined time the system 140 may issue an alert to the user or a third party, such as a guardian, a caretaker, a financial planner, a social worker, and/or the like. In some embodiments, the system 140 may guide a user through the legal planning process by presenting them with questions to determine what legal assistance they need. In some embodiments, the system 140 may provide an interface for directly communicating with an attorney or legal professional, or the like, if the user has questions about the process. The communication may be made electronically, for example, via text chat, video chat, audio chat, and/or the like.

In some embodiments, the system 140 may locate and facilitate communication between a disabled individual, their family, and/or the like and an attorney based on the needs of the individual, or the like. In some embodiments, the system 140 may provide the user, a caretaker, or other person with access to the system with a planning calendar with important dates, appointments, deadlines, and milestones for the user displayed on due dates on the calendar. In some embodiments, users can set reminder notices or alerts based on the events saved and/or displayed on his or her calendar. In some embodiments, the system 140 may provide the ability for a user to sign up for a seminar, or the like regarding the life planning process, disability support systems, and/or the like. In some embodiments, the system 140 may search the Internet, or the like, and seek out and find seminars that would be helpful to the user in the user's geographic area, or the like. In some embodiments, the system 140 may form a partnership with an advertising partner and may receive sponsorship revenue through an electronic payment means by advertising a particular seminar conducted by an advertising partner, or the like. In some embodiments, an administrator may add a seminar to the calendar, or the like.

In some embodiments, the system 140 may be adapted to help people with disabilities and their families create a plan of service and a state funded budget, or the like. The system 140 may also help them identify and access providers that can deliver the services the client and their families are interested in securing. The system 140 may also monitor the person to insure the implementation of the plan meets the client's approval, and when it does not, the system 140 may allow the client and/or family to make the necessary changes. The system 140 may be adapted to integrate and/or receive communications with job coaching agencies, care support agencies and other organizations offering services to people with developmental disabilities.

The system 140 may be adapted to provide similar services on a private pay basis to people with physical disabilities, mental illness and seniors. The system 140 may provide care coordination. Many people with disabilities need assistance in living independently. Families need support in caring for their family member at home. The system 140 may be adapted to act as a personal care coordinator hired by the person with disabilities and their family to assist them in achieving their life goals. The system 140 may monitor the completion of goals and review outcomes. The system 140 may generate or create periodic updates for the person, family and where appropriate and approved other members of a circle of support. A circle of support may comprise Job Coaches, Therapists, Case Managers, and other support professionals provided access to the system 140. In some embodiments the system 140 may provide an interface for one or more members of a circle of support to communicate with each other and/or with the user and/or his or her family, or the like.

In some embodiments, the system 140 may help a person with disabilities create an annual budget that helps the person achieve the maximum independence and support or may generate the budget for review by the user. The budget may earmark revenues from work, Social Security payments, family and other government subsidies to each expense item. The system 140 may arrange meeting between members of the circle of support, the disabled person, a family member, a caregiver, and/or the like to discuss progress made on a plan generated by the system 140 and adjustments that are necessary to the plan, if any. In some embodiments, the system 140 may be adapted to schedule regular meetings to monitor expenses and adjust the budget when appropriate. If requested, the system 140 also assists the person or family with bill paying by issuing credit or facilitating or otherwise procuring a loan to the disabled person or family, or the like.

Many of our disabled persons and their families also need to hire Personal Assistants to provide the necessary supports to live independently or to provide the proper care at home. The system 140 may assist disabled individuals and their families in finding, hiring and training new staff. When necessary the system 140 may also resolve any disputes that may occur. For example, the system 140 may maintain a job database and/or may search existing job databases to find appropriate candidates for a support job. The system 140 may schedule job interviews, may administer payment of job applicants who are hired, and/or the like. The system 140 may be adapted to recommend a job candidate to hire based on criteria entered by the user, or the like. The system 140 may also be adapted to coordinate the schedule of multiple support employees based on the availability of the user.

The system 140 may assist people with disabilities and their families in creating state funded individualized budgets. As an additional service, the system 140 may encourage the person with disabilities and their families to also budget personal assets (e.g., social security and employment income, or the like), along with family funding to properly support the person with disabilities. For those disabled individuals that do not receive services through a government program, such as the Division of Developmental Disabilities, the system 140 may provide of facilitate the acquisition of private pay assistance in creating a comprehensive budget utilizing state, personal and family resources. The system 140 may also assist some disabled persons in bill paying and other financial supports, such as disputes with the IRS and mortgage modifications, or the like.

In exemplary embodiments, the communications module 152 may be adapted to allow the system 140 to communicate with and/or integrate with other systems. For example, the communications module 152 may be adapted to integrate with a state support system, so that users can seamlessly apply for associated state support services by simply clicking an icon to submit an application, or the like. In some embodiments, the system 140 may be adapted to automatically populate an application for support, such as state support, or the like. The system 140 may be adapted to transmit the auto-populated application to a state support system electronically, or may fax and prepare a printed application for the user to mail in. In some embodiments, an alert may be generated and transmitted to the user, a family member, and/or an appropriate state employee, or the like when the system 140 determines a user qualifies for benefits through a state program, or the like.

There are numerous government agencies, private entities, or the like, that support people with disabilities. There are federally sponsored programs, state based programs, county based services and even city and town based services. Some programs, such as, Medicaid are hybrid programs with federal requirements and partial funding but administered by the states through various state agencies. Eligibility requirements differ significantly depending on the government organization or private organization serving a particular population. Some programs, such as Supplemental Security Income (SSI) and Medicaid have financial requirements (maximum assets that can be owned and income that can be earned to insure eligibility). Other programs, such as services from state governments, such as the NJ Division of Developmental Disabilities (DDD), may have disability requirements that may make it difficult to secure services at younger ages, but may result in approvals at older ages when other aspects of a disability may manifest themselves.

In addition to financial and eligibility rules, each government agency may provide one or a combination of services to a targeted group. Some agencies serve only people with developmental disabilities, while others will serve people with a whole range of disabilities, such as, the NJ Division of Vocational Rehabilitation Services (DVRS), which provides employment based services to people with a variety of disabilities. The fact is that the social service system that supports people with disabilities is difficult to navigate to secure services.

A system 100 in accordance with embodiments of the present disclosure may assist disabled people in finding the organizations that provide the services these people's needs based on the data stored in each user's profile. In addition, the system 100 assist clients and their families in applying to various agencies for services or advocating for an increase in services including, for example: Social Security, New Jersey Division of Developmental Disabilities, Medicaid, New Jersey Division of Disability Services, Medicare, New Jersey Traumatic Brain Injury Trust Fund, Food Stamps, New Jersey Division of Vocational Rehabilitation Services, Pharmaceutical Assistance to the Aged and Disabled (PAAD), New Jersey Division of Mental Health Services, Rental Assistance, Energy Assistance, Phone Assistance, Disability Rights, and/or the like. Although some the above agencies and services are available for access only be residents of the state of New Jersey, it is contemplated by and within embodiments of the present disclosure that the system 140 may be adapted for use for residents of any location. For example, the system 140 may be adapted for use in another state or country, and provide information relating to that particular state or country based on the data stored in the user's profile, or the like.

The system 140 may be adapted to streamline and expedite the securing of services while taking the worry and anxiety out of the navigation process by providing a collaborative user profile and a life plan for each user. The system 140 may be adapted to provide assistance to disabled individuals and their families in the advertising for, screening, hiring, training and managing self-hired Direct Support Professionals (personal assistants). The system 140 may also provide similar services to people with brain injury, physical disabilities, mental illness and seniors with disabilities on a private pay basis, or the like.

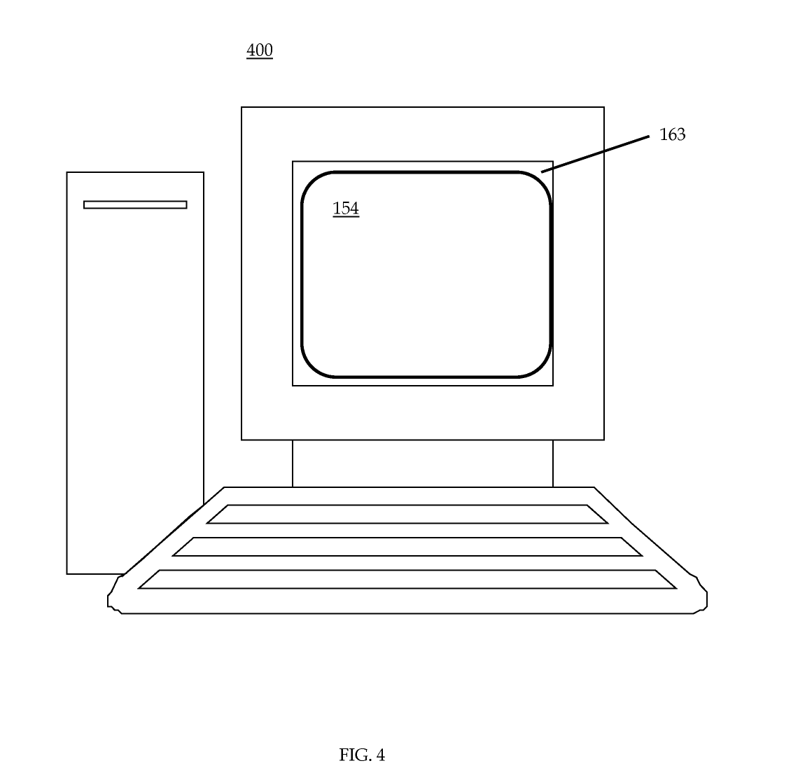

FIG. 4 depicts an exemplary client computer 400 capable of being used with the system depicted in FIGS. 1-3, in accordance with embodiments of the present invention. In exemplary embodiments, the client computer 400 may comprise a display 163. The display 163 may be adapted to display at least an interface 154. In exemplary embodiments, the functionality and appearance of the display may be determined by the interface module 144. The interface 154 may be adapted to display any data and analysis collected, stored, and/or analyzed by a system in accordance with embodiments of the present invention. Although a client computer 160 is depicted as a personal computer in FIG. 4, any computing device may be used. By way of example, a mobile phone, a tablet computer, a laptop computer, and/or the like may be used, to name a few.

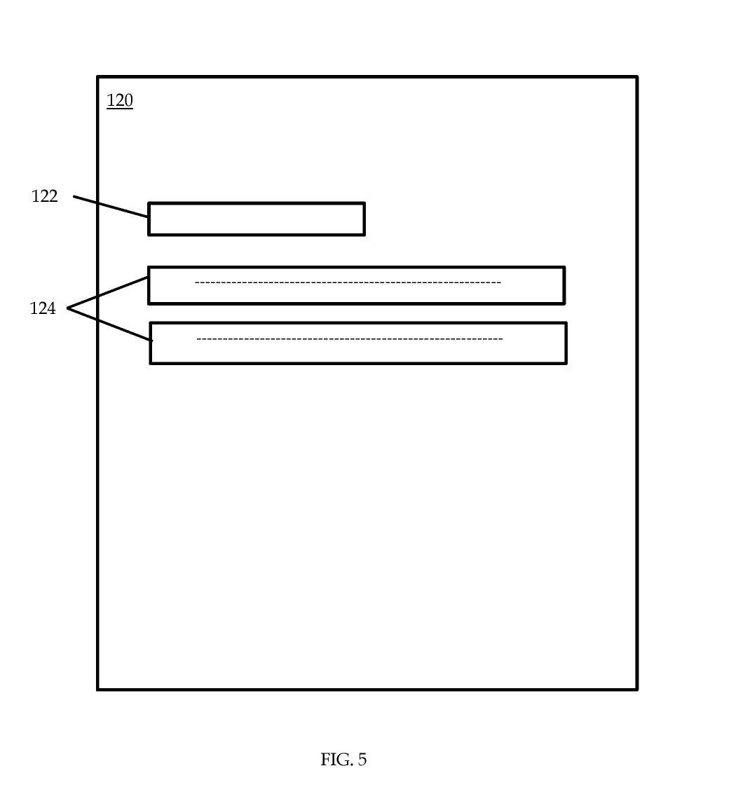

FIG. 5 depicts an exemplary administrative interface 120 in accordance with embodiments of the present invention. In exemplary embodiments, an administrative interface 120 may comprise user search 122 and a user interface 124. Although depicted in particular graphical layouts and configurations herein, it is contemplated that the size, shape, number, scheme, and positioning of the elements depicted in all figures may be modified and each of the elements may be resized, depicted differently, and/or rearranged while maintaining the same functionality described herein, or the like. In exemplary embodiments, the administrative interface 120 may comprise an interface adapted to allow an administrator, or the like to search for a user, add a user, edit a life plan, delete a life plan, view a life plan, print a profile, access a calendar for a user, access reports, and/or the like. Each piece of data may be accessed and/or displayed in real-time, wherein updates do each user's profile may be viewed by the administrator when they are completed. As used herein, the term life plan may refer to the combination of user profile data and one or more plans generated for the user by the system.

In exemplary embodiments a user search 122 may comprise a search interface adapted to allow an administrator, or the like to search through the database of users based on search terms. For example, the user search 122 may search through every data filed in the database associated with user profiles and return results that match terms submitted by an administrator. In alternative embodiments, dropdown lists may be presented to the administrator for selecting categories for generating filtered lists of users. While several searching interfaces are specifically described herein, it is contemplated that any alternative method of searching and/or filtering data records in a database may be used with a system in accordance with the present invention. After the user search returns results, or alternatively a list of every user in the system is presented to the administrator, the user may interact with the user accounts via a user interface 124.

In exemplary embodiments, a user interface 124 may present a list of at least one user and/or options for interacting with each user account. For example, the user interface 124 may comprise a table of all users comprising their name, city, state, account creation date, date of last update, and/or the like. A user interface 124 may provide an administrator with options, for example: add a user, edit a life plan, delete a life plan, view a life plan, print a profile, access a calendar for a user, access reports, and/or the like. In some embodiments, a user interface may be adapted to allow a user to edit, view, transmit and/or the like a user's profile and/or a user's plan, or the like. Adding a user may comprise adding a new user account by entering data relating to a disabled person and/or sending an invitation via electronic communication means to a user to create an account. Editing a life plan may comprise editing data associated with a user's profile and/or editing a plan generated by the system. Deleting a life plan comprises allowing an administrator to erase a life plan of a given user and/or delete an entire user account. View a life plan may be adapted to allow a user to view the user's profile data and any plans generated by the system. In accordance with exemplary embodiments, access to certain or all options may be restricted to certain user accounts, for example users with administrative access, or the like.

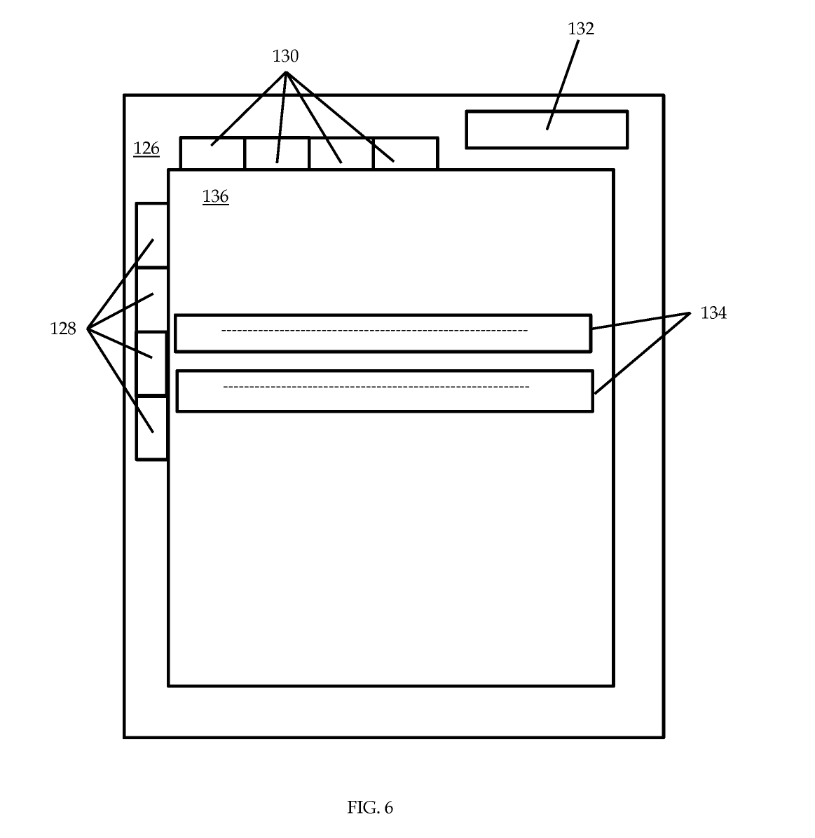

FIG. 6 depicts an exemplary profile interface 126, in accordance with embodiments of the present invention. An exemplary profile interface 126 may be adapted to display all data related to a user's profile and allow a user to input data, modify data, and/or the like. A profile interface 126 may comprise category tabs 128, subcategory tabs 130, an options interface 132, a data interface 134, a data module 136, and/or the like. In some embodiments, category tabs 128 may comprise selectable tabs comprising profile data arranged in profile categories, each tab 128 adapted to access an individual category, or the like. Profile categories may comprise a personal profile, an education profile, a personal care category, a medical profile, a home skills category, a vocational profile, a community support category, a legal planning category, a personal finance category a relationships category, a future care category, and/or the like.

In exemplary embodiments the system may provide access to one or more subcategory tabs 130. The one or more subcategory tabs 130 may comprise subcategories or subsets of data, questions, assessments, and/or the like that are categorized underneath each category tab 128. Each subcategory tab 130 is selectable to provide access to input data and/or view data under a subcategory of data related to the category of an associated category tab 128, or the like. In some embodiments, the system may provide an options interface 132. The options interface 132 may generally display the name or user account of a disabled individual associated with the information displayed on a screen when the category tabs 128 and/or subcategory tabs 120 are selected.

In some embodiments, the options interface may provide the option of printing, exporting, and/or saving a displayed page of data or the entire profile and plans for a user. In exemplary embodiments, when a category tab 128 and/or subcategory tab 130, is selected, the user may be provided access to a data interface 134 displayed via a data module 136. The data module 136 may be adapted to display all data saved and/or associated with a category tab 128 and/or a subcategory tab 130, or the like. In some embodiments, the data interface 134 may be adapted to provide a user access to enter or modify data associated with a disabled individual. In some embodiments, sections of the data module 136 and each individual data interface 134 may be restricted and may only be viewed and/or edited by authorized users approved or assigned the appropriate access by an administrator, or the like. In some embodiments, a data interface 134 may comprise a portal for accepting data, which may comprise text, pictures, videos, audio, combinations thereof, and/or the like.

A personal profile may be accessed by a category tab 128 and may provide access to data and/or assessments related to personal details for a disabled person. A personal profile may store, receive, and display personal data. Personal data may comprise various data types in various sub categories, accessible via one or more subcategory tabs 130. Subcategory tabs may comprise selectable tabs for accessing different subcategories within the system. For example, subcategory tabs 130 for personal profile may comprise personal profile, plan participants, character strengths, social skills, leisure activities, physical activities, table of contents, historical narrative, fears, food, preferences, likes and dislikes, emotions and feelings, and/or the like.

In some embodiments, a personal profile subcategory tab 130 may provide access to an interface for entering identification or personal data. For example, identification or personal data may comprise a perspective (e.g., a particular user account, the name of a user, and/or identity of a party that has entered the data on behalf of the disabled person or in observation of the disabled person); contact and identification details (e.g., prefix, first name, middle initial, last name, suffix, preferred name, street address, city, state, zip code, county, email address, home phone, cell phone, social security number, date of birth, marital status, sex, race/ethnicity, citizenship, blood type, religion, languages spoken, languages understood, or the like); body measurements (e.g., height, weight, sleeve length, neck size, waist size, pant length, shoe size, or the like); disability diagnosis; day activity (e.g., name of activity, phone number, contact name, organization, duties); religious organization (e.g., organization name, address, city, state, zip code, phone number, activities); final arrangements (e.g., an indication if they have been made, funeral home, address, city, state, zip code, phone number, funeral details); and account information (e.g., username, password, plan type, or the like). In exemplary embodiments, a plan participant's subcategory tab 130 may provide access to enter plan participant data. Plan participant data may comprise a perspective; the names of the individuals who entered data into the system for this user; names of people, advisors, or agencies the system recommends that the disabled person contact, and a listing of important changes to the plan since a last plan period, separated by username and/or the like. In exemplary embodiments, the system may be adapted to ask questions to the user and collect data. The questions or requests for data may be configured by an administrator and may be edited and updated in real-time so that current users of the system may have access to an administrator's edits and updates to the questions posed in each category tab 128 and subcategory tab 128 in real time. All of the category tabs 130 and subcategory tabs 130, when selected may present a perspective interface for indicating which user (e.g., the disabled individual, a family member, a guardian, a parent, a friend, a caregiver, a healthcare provider, a therapist, a counselor, an advisor, and/or the like) entered the associated data. In some embodiments, the perspective interface may be automatically populated based on which user ID is actively logged into the system.

In some embodiments a character strengths subcategory tab 130 may provide access to enter character strengths data. In exemplary embodiments, character strengths data may comprise an assessment of a disabled person's character strengths. Each character strength may be graded on a scale and assessed a grade, wherein the grade may comprise always, frequently, sometimes, never and a remarks portion that allows a user to enter in specific remarks about character strengths. In some embodiments, the grade may be selectable, for example, via a radio button. In some embodiments alternative scales and grading systems may be used. The character strengths may comprise, for example, reliable; honest; respectful; polite; patient; generous; thoughtful; gentile; kind; friendly; upbeat; even-tempered; good listener; good sense of humor; easy to get along with; fun to be with; likes doing things with others; can help others work out their problems; has a tendency to brag; a good friend; proud; confident; hard working; energetic; cooperative; flexible; neat and organized; good common sense; good team member; tries to follow instructions; likes doing things with others; asks others for help; takes initiative; willing to learn; usually on time; complete what I start; meets deadlines; and/or the like.

In some embodiments a social skills subcategory tab 130 may provide access to enter social skills data. In exemplary embodiments, social skills data may comprise a graded scale for each social skill of a disabled person, similar to the scale presented and described above with respect to the character strengths subcategory tab 130. The grades may comprise best skill, good skill, moderate skill, learn or improve, and/or the like. In some embodiments a remarks section may be presented for allowing a user to enter remarks on each social skill. In some embodiments a perspective interface may be provided to identify the user entering the data related to the disabled individual. A social skill may comprise, for example: listening; talking; attracting; understanding; taking directions; giving instructions; encouraging; supporting; helping; coaching; teaching; getting attention; being heard; amusing; convincing; speaking in public; entertaining groups; introducing; organizing; motivating; leading; solving problems; and/or the like.

In some embodiments a leisure activities subcategory tab 130 may provide access to enter leisure activities data. In exemplary embodiments, leisure activities data may comprise a list of leisure activities a user partakes in and a grading scale for each activity. The leisure activities subcategory tab 130 may also comprise a frequency selector adapted to allow a user to input how often the disabled individual partakes in each leisure activity, a year last completed indicating the year the disabled individual last completed the activity, and a remarks section for entering remarks about each activity. In exemplary embodiments, the grading scale may comprise grades of favorite, like, moderate like, dislike and/or the like and may indicate the degree in which a disabled individual enjoys each leisure activity. Some examples of leisure activities may comprise babysitting,; beauty and hair care; belonging to a club; card games; collecting things; computer games; cooking; creating poems or songs; dancing; drawing; going out to eat; attending religious services; housekeeping; listening to music; needlecrafts; painting; pets; playing an instrument; puzzles; reading; shopping; table games; talking on the telephone; using the library; video games; visiting friends; watching TV; watching movies; woodworking; and/or the like.

In some embodiments a physical activities subcategory tab 130 may provide access to enter physical activities data. In some embodiments, physical activities data may comprise the same grading scale, frequency interface, year last done interface, remarks interface, and/or the like as the leisure activity subcategory tab 130. In exemplary embodiments, physical activities data may comprise data related to physical activities a disabled user may partake in. For example, some physical activities listed may include: archery, baseball, basketball, bicycling, boating, bowling, camping, fishing, flying a kite, football, golf, hiking, hockey, horseback riding, hunting, jogging, lacrosse, mountain climbing, playing catch, playing Frisbee, racquetball, riflery, rollerblading, skateboarding, skating, soccer, swimming, taking pictures, taking walks, tennis, volleyball, walking the dog, and/or the like.

In some embodiments a table of contents subcategory tab 130 may provide access to enter table of contents data. In exemplary embodiments, table of contents data may comprise a table of contents, including page numbers, generated in a report comprising a user profile and/or a user plan. In some embodiments a historical narrative subcategory tab 130 may provide access to enter historical narrative data. In exemplary embodiments, historical narrative data may comprise historical data relating to a disabled individual based on data received from one or more parties via the systems and methods presented herein.

In some embodiments a fears subcategory tab 130 may provide access to enter fears data. In exemplary embodiments, fears data may comprise a listing of fears and an indicator for indicating which of the listing of fears the user experiences and a remarks portion for entering remarks about each fear. In some embodiments, a listing of fears may comprise being alone; being in a crowd; not knowing anyone; talking to people you don't know; being ignored; not being understood; not understanding; not knowing the answer; making a mistake; saying the wrong thing; being laughed at; being different; hurting someone's feelings; claustrophobia; heights; fire; new situations; water; drowning; bugs; spiders; snakes; loud noises; needing help; being a bother; being physically hurt; falling; getting lost; embarrassing yourself; embarrassing your family; embarrassing your friends; not having a chance; not controlling your life; not begin yourself; being rejected; being told no; not being allowed to dream; thunderstorms; explosions; darkness; falling; flying; car/bus; trains; amusement rides; and/or the like.

In some embodiments a food preferences subcategory tab 130 may provide access to enter food preferences data. In exemplary embodiments, food preferences data may comprise a listing of food categories and types; a grading scale; a frequency indicator; a remarks interface; and/or the like. The grading scale may comprise rating like favorite; like; moderately like; dislike; and/or the like. Some examples of food types may include vegetables; a listing of various types of vegetables; nuts; fruits; meats—beef; fowl; lamb; pork; seafood; breads; cereal; eggs; juice and milk; specialty foods; ice cream; cookies; snacks; beverages—hot; restaurants; and/or the like.

In some embodiments a likes and dislikes subcategory tab 130 may provide access to enter likes and dislikes data. In exemplary embodiments, likes and dislikes data may comprise data related to the likes and dislikes of a disabled person. The likes and dislikes data may comprise a list of items the disabled person may like and/or dislike. In some embodiments, the likes and dislikes subcategory tab 130 may provide access to a list of items, an option to import data from another category tab 128 and/or subcategory tab 130, and a text field allowing a user to enter data regarding each time. The list of items may comprise, for example, favorite possessions; favorite places; favorite leisure activities; favorite foods; food likes; favorite vacations; personal character strengths; favorite structured activities; favorite physical activities; favorite TV shows; social skills; favorite movies; favorite colors; favorite childhood memories; fears; food dislikes; other dislikes to be aware of; and/or the like. In some embodiments, the data presented in the likes and dislikes subcategory tab 130 may be automatically populated from data received in other categories 128 and/or subcategories 130, or the like.

In some embodiments an emotions and feelings subcategory tab 130 may provide access to enter emotions and feelings data. In exemplary embodiments, emotions and feelings data may comprise a listing of emotions and behavior types and a text field asking how the disabled person expresses feelings and emotions and how to best change the behavior if necessary and/or the like. In some embodiments, the list of emotions and feelings may comprise love; anger; joy; humor; laughter; sadness; what motivates them; how best to resolve conflicts; how to correct behavior; what are your greatest challenges; what are your dreams; types of people he/she likes best; types of people he/she likes least; fears; and/or the like.

In some embodiments, the system may be adapted to provide an education profile accessible via a category tab 128 and/or the like. An education profile may comprise various subcategories accessible via subcategory tabs 130, or the like. For example, an education profile may comprise one or more of the following subcategories: an education summary, a learning style, and an education skills survey. In some embodiments an education summary subcategory tab 130 may provide access to enter education summary data. In exemplary embodiments, education summary data may comprise data relating to the educational level of the disabled person. In some embodiments, education summary data may comprise whether the person can read; whether the person can write; a reading grade level; a writing grade level; a math grade level; an education program description; learning styles; information gathering -auditory language, visual language, auditory numeric, visual numerical, auditory-visual-Kinesthetic; learning preference—individual or group learning; expressive preference—oral or written; attitudes about school, learning, classes, exams, teachers, classmates; education aptitudes (e.g.; what did the disabled individual did well in school, or the like); learning accommodations (e.g., what is required for the disabled user to learn effectively—sit in front of the class, tutors, peer buddy, or the like).

In some embodiments a learning style subcategory tab 130 may provide access to enter learning style data. In exemplary embodiments, learning style data may comprise an indication on what methods the disabled individual may learn something from. For example, the learning style subcategory tab 1340 may comprise a listing and description of learning styles, such as auditory language; visual language; visual numerical; individual learner; oral expressive; and/or the like.

In some embodiments an educational skills survey subcategory tab 130 may provide access to enter educational skills survey data. In exemplary embodiments, educational skills survey data may comprise a grading scale for education skills in categories such as language arts, math, science, and or the like, a preference level for each educational skill, and for each subcategory of educational skill. In some embodiments, example subcategories of educational skills may comprise words; speech; reading; writing; communication; grammar; composition; creative writing; short stories; poetry; public speaking; famous authors; journalism; American literature; world literature; ancient literature; numbers; money; addition/subtraction; multiplication/division; algebra; geometry; trigonometry; statistics; calculus; accounting; earth science; life science; geography; ecology; biology; anatomy; chemistry; physics; psychology; and/or the like. In some embodiments, the educational skills survey subcategory tab 130 may comprise an interface allowing a user to indicate the disabled person is interested in learning more about and/or developing an educational skill.

In exemplary embodiments, the system may provide a personal care category tab 128. The personal care category tab 130 may provide access to a number of subcategory tabs 130 that indicate an individual's ability to care for themselves. For example, some subcategory tabs 130 may comprise communication skills; hygiene; social behavior; and/or the like. In some embodiments a communication skills subcategory tab 130 may provide access to enter communication skills data. In exemplary embodiments, communication skills data may comprise analysis of receptive communication; analysis of expressive communication; and/or the like. Analysis of receptive communication may comprise any hearing problems; language understood by the person; understanding of the spoken word; following simple directions; and levels of comprehension. Levels of comprehension may comprise: comprehends complex conversation involving abstract ideas; remembers tasks/directions for 5-7 days; comprehends simple conversations involving routine matters; remembers compound directions for at least 24 hours; comprehends phrases, two-three words: come here, sit down; remembers compound directions for at least 24 hours; comprehends simple phrases or single words: yes, no, sit, stop: requires frequent verbal prompts to remember directions; comprehends only with modeling prompts/gestures; requires frequent verbal & physical prompts to remember directions; Does not comprehend verbal, visual, or gestural communication: does not remember directions, requires hand-over-hand assistance to participate in activity; and/or the like.

In some embodiments a hygiene subcategory tab 130 may provide access to enter hygiene data. In exemplary embodiments, hygiene data may comprise a grading of hygiene skills. The grading may comprise: independent; needs reminders; needs verbal directions; needs physical assistance; no observation; an interface; and/or the like. Hygiene skill categories may comprise toileting; washing and bathing; dressing; eating; and/or the like. Hygiene skills may comprise: uses adult incontinence products; day; night; toilets self; wipes self with toilet paper; washes hands after toileting; cares for menstruation; appropriate toilet habits; bladder accidents (night/day/freq.); bowel accidents (night/day/freq.); washing and bathing independent needs reminders needs verbal directions needs physical assistance no observation ; washes and dries hands; washes and dries face; bathes self in bathtub; showers self; turns on & regulates water temp.; washes hair; dries self; uses deodorant; combs/brushes hair; tooth and mouth care; brushes own teeth; puts toothpaste on brush; dentures worn regularly; cares for own dentures; blows and wipes own nose w/tissue; shaving; uses safety razor; uses electric razor; dressing independent needs reminders needs verbal directions needs physical assistance no observation ; undresses self; buttons; snaps; zippers; fastens a buckle; hooks own bra; ties shoes; dresses self completely; changes clothing regularly; matches colors/patterns; selects seasonal clothing; feeds self with spoon; feeds self with fork; cuts food with a knife; eats with fingers; drinks from cup or glass; and/or the like.

In some embodiments a social behavior subcategory tab 130 may provide access to enter social behavior data. In exemplary embodiments, social behavior data may comprise analysis of social behavior, analysis of community awareness, and/or the like. In exemplary embodiments, social behavior analysis and analysis of community awareness may comprise a series of questions, for example: is this person sexually active?; how are emotions, such as anger or frustration displayed?; how are symptoms of illness displayed?; does this person smoke?; does this person drink alcohol?; does this person vote?; is this person a good self-advocate?; does this person: a) wander off if not closely supervised? b) run away? c) have unusual sleep patterns?; is it safe for this person to be around children?; does this person demonstrate appropriate behavior during community activities?; is this person aware of household dangers (e.g., stairs, heaters, electric outlets, cleaners, stoves, fireplaces, etc.)?; does this person demonstrate awareness of community dangers: a) traffic b) being overly friendly with strangers c) can read or is aware of danger; can this person tell time?; is this person visually impaired?; can this person make purchases? a) with cash, make change? b) with debit/credit card?; describe the assistance this person needs to handle their finances?; and/or the like.

In some embodiments a medical profile category tab 128 may be provided to the user. The medical profile category tab 128 may provide access medical subcategory tabs 128, such as medical conditions; medications; medical awareness; medical groups; medical summary; and/or the like. In some embodiments a medical conditions subcategory tab 130 may provide access to enter medical conditions data. In exemplary embodiments, medical conditions data may comprise a listing of any medical problems or related conditions the disabled person has experienced; an indication of whether these problems or conditions are current; a history of problems and comments section for indicating the history of each problem or condition, and/or the like. Medical conditions data may also comprise visual condition as observed by a user; mobility condition; and/or physical equipment required for mobility (e.g., manual wheelchair; motorized wheelchair; stroller; walker; crutches; cane; hearing aid; helmet; braces; and/or the like).

In some embodiments a medications subcategory tab 130 may provide access to enter medications data. In exemplary embodiments, medications data may comprise a listing of allergies; medications (e.g., medication, type, purpose, dosage, times to administer, prescribing physician, date started taking, date stopped taking, and/or the like); hospitalizations; and/or the like. In some embodiments a medical awareness subcategory tab 130 may provide access to enter medical awareness data. In exemplary embodiments, medical awareness data may comprise a list of questions regarding ability to respond to health needs which endanger the physical health and safety of the disabled individuals; vaccinations; immunization record; methods of administering medications; ongoing nursing needs; other medical problems; complications at birth and unusual childhood diseases; therapies (e.g., speech, physical, psychological, occupational, or the like); and a details interface for entering text relating to medical conditions of a disabled person, or the like.

In some embodiments a medical groups subcategory tab 130 may provide access to enter medical groups data. In exemplary embodiments, medical groups data may comprise data related to healthcare providers that are currently treating, have treated, or are scheduled to treat a disabled person. In some embodiments, the medical groups subcategory tab 130 may comprise various sub-tabs for accessing data relating to different healthcare providers, for example, physicians, dentists, therapists, and/or the like. In some embodiments the medical groups subcategory tab 130 may comprise an insurance sub-tab for providing insurance information for the disabled individual. In some embodiments, one or more of the sub-tabs may comprise a group name, a physician name, a specialty, an address, a city, a state, a zip code, a phone number, an email, a frequency of visits, a dental group name, a dentist name, an insurance group number, an insurance group name, an insurance company, a policy number, an insurance company phone number, an insurance company email, an address, a city, a state, a zip code, and/or the like. In some embodiments a medical summary subcategory tab 130 may provide access to enter medical summary data. In exemplary embodiments, medical summary data may comprise interfaces for providing text relating to the following data categories: summary of medical issues others should know; summary of self-help issues others should know; summary of behavioral issues others should know; summary of awareness issues others should know; and/or the like.

In some embodiments, a system in accordance with the present disclosure may comprise a home skills category tab 128. A home skills category tab 128 may provide access to subcategory tabs 130 that may comprise data relating to the following categories, or the like: home skills and independent living; current residential preferences; independent living requirements; direct support characteristics. In some embodiments a home skills and independent living subcategory tab 130 may provide access to enter home skills and independent living data. In exemplary embodiments, home skills and independent living data may comprise a graded scale of certain home skills, or the like. The graded scale may comprise grades from high skill, moderate skill, low skill, never tried, and/or the like. The graded scale may allow a user to indicate a disabled individual's grade for one or more home skills. In some embodiments, the graded scale may comprise an interface allowing a user to select a disabled user's level of independence and/or provide comments. In some embodiments, a level of independence may comprise independent, needs reminders, needs supervision, done by others, and/or the like. In some embodiments, home skills may comprise skills in using kitchen appliances, ability to cook meals with certain appliances, ability to plan meals and diet, cleaning, decorating and repairing; using tools; home maintenance; safety skills; personal safety/safe preservation skills; finance skills; and/or the like.

In some embodiments a current residential preferences subcategory tab 130 may provide access to enter current residential preferences data. In exemplary embodiments, current residential preferences data may comprise interfaces allowing a user to answer various questions relating to the current residential preferences of a disabled individual. For example, the various questions may comprise: what did you like about where you live now; what don't you like about where you live now; do you want to make any changes about where you live; is there any other kind of help you would like or need in your home; and/or the like.

In some embodiments an independent living requirements subcategory tab 130 may provide access to enter independent living requirements data. In exemplary embodiments, independent living requirements data may comprise may provide an interface allowing users to enter independent living requirements questions. For example, independent living requirements data may indicate what kind of help (e.g., people, assistive devices, accessibility, transportation, and/or the like) does a disabled individual need to live in his or her home. Some categories of help required may comprise meal planning/shopping; meal preparation/cooking; maintaining daily schedule; housekeeping/cleaning; home maintenance—interior & exterior (e.g., plumbing, electrical, snow shoveling); transportation; bill paying; medical needs; personal grooming/hygiene; and/or the like. In some embodiments a direct support characteristics subcategory tab 130 may provide access to enter direct support characteristics data. In exemplary embodiments, direct support characteristics data may comprise data related to the characteristics of the people who support a disabled individual best. Characteristics may comprise energy level; gender preference; transportation requirements; positive interaction techniques; activities requiring support; other characteristics; and/or the like.

In some embodiments, a system in accordance with the present disclosure may comprise a vocational profile category tab 128 adapted to provide access to subcategory tabs 130 related to the ability of a disabled individual to maintain employment. In some embodiments, a vocational profile category tab 128 may provide access to subcategory tabs 130 comprising information related to: vocation aptitudes; vocation temperament; vocation style; vocation history; vocation readiness; vocation summary; and/or the like. In some embodiments a vocation aptitudes subcategory tab 130 may provide access to enter vocation aptitudes data. In exemplary embodiments, vocation aptitudes data may comprise data relating to language aptitude; conceptual aptitude; numerical/mathematical aptitude; spatial aptitude; for perception aptitude; clerical aptitude; manual-motor coordination aptitude; finger dexterity aptitude; mechanical aptitude; color discrimination aptitude; artistic aptitude; musical aptitude; and/or the like. In some embodiments a vocational temperament subcategory tab 130 may provide access to enter vocational temperament data. In exemplary embodiments, vocational temperament data may comprise the type of work that appeals to a disabled individual, which may comprise a graded scale including various grades (e.g., good match, moderate match, not suited, not sure, and/or the like), a comments section, and/or the like.

In some embodiments a vocation style subcategory tab 130 may provide access to enter vocation style data. In exemplary embodiments, vocation style data may comprise data relating to the vocational style preferences of a disabled individual. For example, vocation style data may comprise preferred work environments (e.g., inside, outside, and/or the like); preferred work relationships (e.g., with people, closely supervised, supervisory, and/or the like); job qualities (e.g., having a regular schedule, a flexible schedule, and/or the like); dress (e.g., casual, businesslike, uniform, and/or the like); production rate; work climate; activities; motor skill requirement; noise level; work materials; and/or the like. In some embodiments a vocation history subcategory tab 130 may provide access to enter vocation history data. In exemplary embodiments, vocation history data may comprise data related to a disabled individuals work history and observed vocational skills. Work history may comprise current or previous employer names, addresses, hire dates, termination dates, contact information, job description, pay rate, hours worked/week, summary of work experience, weekly pay, and/or the like. Observed vocational skills may comprise occupational interests and preferences; aptitudes and capabilities in a work setting; positive worker habits/work style; performances vs. industry validated standards; support needs and what should be changed about the individual's work; other important work information; and/or the like.

In some embodiments a vocation readiness subcategory tab 130 may provide access to enter vocation readiness data. In exemplary embodiments, vocation readiness data may comprise data related to the readiness of an individual to begin employment and any obstacles, scheduling or otherwise, that may prevent a disabled individual from working at a specific position. For example, vocation readiness data may comprise, travel considerations/schedule, family interest, top three vocational interests, employment search questions (e.g., readiness for an interview, powerful resume, motivation for a job), and/or the like. In some embodiments a vocation summary subcategory tab 130 may provide access to enter vocation summary data. In exemplary embodiments, vocation summary data may comprise on overview of a disabled individuals readiness for employment. For example, vocation summary data may comprise: a vocational aptitude summary; a vocational temperament preference; transportation requirements; vocational style preferences; work history summary and current vocational interests; employment search readiness, and/or the like.

In exemplary embodiments, a system in accordance with the present disclosure may comprise a community support category tab 128 providing access to programs available for use by a disabled individual. For example, a community support category tab 128 may comprise subcategory tabs 130 comprising government programs; community providers; family advisors; and/or the like. In some embodiments a government programs subcategory tab 130 may provide access to enter government programs data. In exemplary embodiments, government programs data may comprise information related to available government programs. For example, government programs data may comprise an organization name, if the user is registered for that organization, a contact name, an email address, a phone number, a mailing address, the details about the program and the disabled individual's (or caretaker's, or the like) interactions with the government programs. In some embodiments, a listing of all contacts made with each government program may be presented to a user via the government programs/community providers tab 130.

In some embodiments a community providers subcategory tab 130 may provide access to enter community providers data. In exemplary embodiments, community providers data may comprise data relating to social organizations and/or the like available for a disabled individual. For example, community providers data may comprise the following data for social organizations: the organization name, an indication on whether the user is registered, a contact name, email address, phone number, address, city, state, zip code, details, and/or the like. In some embodiments a family advisors subcategory tab 130 may provide access to enter family advisors data. In exemplary embodiments, family advisors data may comprise contact information and identification information for family advisors. Family advisors may comprise an attorney, accountant, financial planner, life planner, and/or the like. In some embodiments, the system may be adapted to provide direct contact to a family advisor via text message, email, video chat, voice chat, text chat, and/or the like by selecting an option to contact the family advisor.

In exemplary embodiments, a legal planning category tab 128 may provide access a checklist relating to recommended and/or typical legal documents and the locations of each document. In some embodiments a financial/legal planning survey subcategory tab 130 may provide access to enter financial/legal planning survey data. In exemplary embodiments, financial/legal planning survey data may comprise legal documents of parents or guardians; if guardianship is not being applied for, legal documents of person with disabilities; financial plans of parents or guardians; and/or the like. In some embodiments, the legal documents of parents or guardians subsection may comprise questions asking whether the disabled person has an up-to-date will; if the will is notarized; an up-to-date power of attorney; an up-to-date special needs trust; if the trust is notarized; guardianship papers, and/or the like. In some embodiments, the legal documents of the person with disabilities may comprise if a will is up-to-date; if the will is notarized; if the power of attorney is up-to-date; if the healthcare directive is up-to-date; and/or the like. In some embodiments, the financial plans of the parents or guardians may comprise question such as: does the family have health insurance covering the person with disabilities; does the family have life insurance earmarked for the persons with disabilities; is it “2nd to die” insurance; face amount of earmarked insurance money; is the family saving for a future residence for the person with disabilities; and/or the like.

In some embodiments of the present disclosure a personal finance category tab 128 may be provide information relating to the personal finances of a disabled person, separated by subcategory tabs 130, for example, a monthly income subcategory tab 130 and a monthly expenses subcategory tab 130. In some embodiments a monthly income subcategory tab 130 may provide access to enter monthly income data. In exemplary embodiments, monthly income data may comprise data describing and identifying any insurance information (e.g., burial, insurance, private health insurance); trust funds; personal savings; military pensions; employment income; legal settlement; government benefits; a monthly income summary; and/or the like.

In some embodiments, the monthly income summary may comprise an indication of total investment income, government benefits, employment income, and a total monthly income, and/or the like, calculated by the system. In some embodiments a monthly expenses subcategory tab 130 may provide access to enter monthly expenses data. In exemplary embodiments, monthly expenses data may comprise the monthly expenses of a disabled person. For example, monthly expenses may comprise monthly rent; utilities; maintenance; cleaning items; laundry costs; medical/dental visits; therapy; nursing services; meals of attendants; drugs, medicine, etc.; transportation ; fees; books; glasses; live-in; respite; custodial; sports; spectator sports; vacations; camps; transportation; elevator; repair of equipment; computer; audio books; ramp; guide dog; hearing aids; wheelchair; haircut; phone; cigarettes; personal needs; transportation; workshop fees; attendant; training; meals; snacks; special foods; automobile; medical/dental; burial; housing/rental; and/or the like. In some embodiments, the monthly expenses subcategory tab 130 may comprise a total summary of monthly expenses calculated by the system, which may include total monthly income; total monthly expenses; supplementary funds and/needs today; and/or the like.

In some embodiments of the present disclosure, a system may be adapted to present a relationships category tab 128 providing information about important relationships a disabled person has. A relationships category tab 128 may provide access to several subcategory tabs 130, for example tabs of a relationship survey, a people map, important people & relationships; and/or the like. In some embodiments a relationship survey subcategory tab 130 may provide access to enter relationship survey data. In exemplary embodiments, relationship survey data may comprise information about important relationships in the user's life and questions regarding these relationships. Some example questions may include: how would you describe the person with special needs' ability to make friends; does the person with special needs socialize well with friends; does the person with special needs associate well with brothers and sisters; how does the person respond to supervision (e.g., suggestions about free time use); does the family have a circle of friends that meet regularly to discuss issues pertaining to the person; and/or the like.

In some embodiments a people map subcategory tab 130 may provide access to enter people map data. In exemplary embodiments, people map data may comprise a listing of important people in a disabled person's life. For example, the important people may comprise family, people who support the person at work, school, training; people whose job it is to support the person at home and other places, friends, and/or the like. In some embodiments an important people and relationships subcategory tab 130 may provide access to enter important people and relationships data. In exemplary embodiments, important people and relationships data may comprise details for each important person in a disabled user's life. For example, important people and relationships may comprise the following information about a person having a relationship with a disabled person: the relationship; marital status; email; phone numbers; name; religion; languages; address; date of birth; employer; job title; job contact; job phone number; hours; emergency contact; whether or not they are deceased; a veteran; their citizenship; guardianship; if they are a trustee; representative payee; and/or the like.

In some embodiments, a system in accordance with the present disclosure may comprise a future care category tab 128. A future care category tab may comprise routines, evaluations, plans, and goals for a disabled person and may provide access to subcategory tabs 130 such as weekday routine; weekend routine; routine evaluation; critical plan; goal & action plan; and/or the like. In some embodiments a weekday routine subcategory tab 130 may provide access to enter weekday routine data. In exemplary embodiments, weekday routine data may comprise information about activities a disabled user participates in. For example, weekday routine data may comprise an activity day of the week; time of day; description; start time; end time; and/or the like for each activity. In some embodiments, weekday routine data may comprise other occasional weekday activities to be aware of. In all instances described herein, when data is mentioned the data may be entered by any party with appropriate security access. For example, any user, a disabled individual, a healthcare provider, a caregiver, a counselor, a therapist, and/or the like or anyone responsible for some aspect of a disabled individual's life, may have access to entering any of the data discussed herein.

In some embodiments a weekend routine subcategory tab 130 may provide access to enter weekend routine data. In exemplary embodiments, weekend routine data may comprise data describing a disabled individual's habits during the course of a typical weekend, and/or the like. For example, weekend routine data may comprise a day of the week, a time of day, a description, a start time, an end time, and/or the like of each activity. Weekend routine data may also comprise occasional weekend activities the disabled individual participates in and the user should be aware of, or the like. In some embodiments a routine evaluation subcategory tab 130 may provide access to enter routine evaluation data. In exemplary embodiments, routine evaluation data may comprise data describing the user's evaluation of the disabled individual's routines. In some embodiments, routine evaluation data may comprise what a great weekday would be; what a bad weekday would be; what a great weekend would be; what a bad weekend would be; and/or the like. The routine evaluation subcategory tab 130 may comprise text interfaces that allow a user to enter text descriptions for the routine evaluation data categories (i.e., a great weekday would be, a bad weekday would be, and the like).

In some embodiments a critical plan subcategory tab 130 may provide access to enter critical plan data. In exemplary embodiments, critical plan data may comprise data describing the user's evaluation of interactions with a disabled individual. In some embodiments, critical plan data may comprise what is important to the disabled person; things to figure out (e.g., unknown personality characteristics, unexplained behavior, and/or the like); what works, makes sense, the upside (e.g., activities and/or interactions with the disabled person that improve his or her mood or quality of life); what does not work, make sense, the downside (e.g., activities and/or interactions with the disabled person that not improve his or her mood or quality of life); and/or the like. The critical plan subcategory tab 130 may comprise text interfaces that allow a user to enter text descriptions for the critical plan data categories (i.e., what is important to the person, things to figure out, and the like).

In some embodiments a goal and action plan subcategory tab 130 may provide access to enter goal and action plan data. In exemplary embodiments, goal and action plan data may comprise data describing the goals of a disabled individual and the associated actions, objectives, or the like. In some embodiments, goal and action plan data may be separated into various subcategories such as education; employment; residential; recreational; transportation; medical; physical activities; and/or the like. The goal and action plan subcategory tab 130 may provide various interfaces for entering data (e.g., text, video, picture, or the like) relating to each subcategory (e.g., education; employment; residential, or the like). In some embodiments, the data relating to each subcategory may comprise goals (e.g., the goals if a disabled individual for each subcategory); objectives (e.g., the objectives and/or required activities to accomplish in furtherance of each goal); a person responsible (e.g., a guardian, caretaker, healthcare provider, advisor, or the like who is responsible for overseeing completion of the goals/objectives, setting goals/objectives, modifying goals, eliminating goals/objectives, and/or like); an evaluation procedure; timing (e.g., the time period a disabled individual takes to complete a goal/objective, the time period a disabled individual is expected to take to complete a goal/objective, and/or the like); and/or a deadline field (e.g., a target date and/or time a disabled individual should complete a goal/objective, a deadline for the disabled individual to complete a goal/objective); and/or the like.

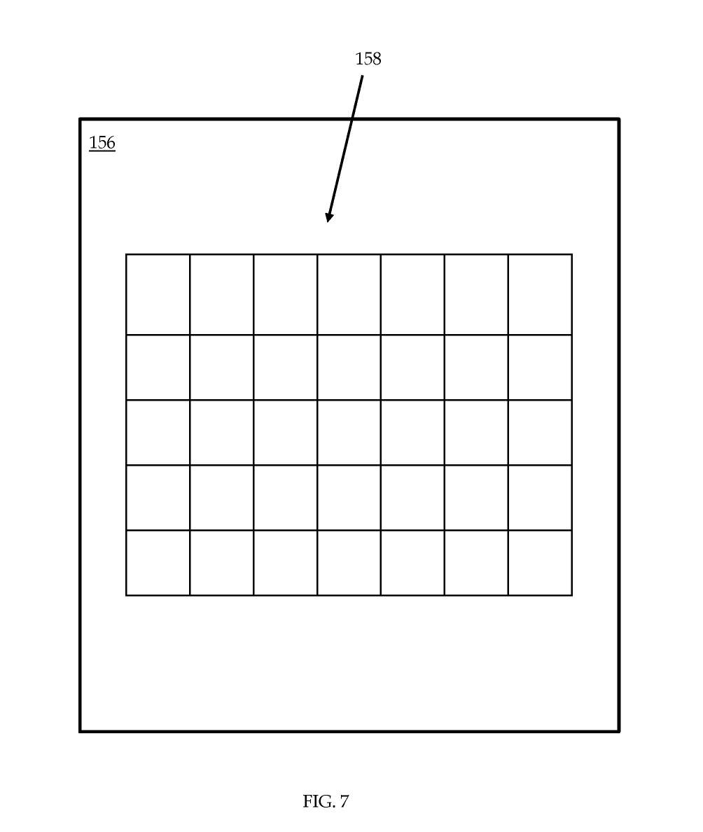

FIG. 7 depicts an exemplary calendar interface 156 in accordance with embodiments of the present invention. A system in accordance with exemplary embodiments of the present invention may be adapted to generate and/or display a calendar 158 or activity list based upon all data entered into the system, as described herein. In some embodiments, the system may automatically schedule time for completion of daily tasks, such as medical treatment, counseling, recreational activities, employment activities, and/or the like. The system may be adapted to prioritize each task based on a weight assigned to the importance of each task. For example, a critical medical treatment will be assigned a higher priority than a recreational activity, or the like, by the system.

In exemplary embodiments, the system may analyze all data received and stored in the system for a disabled individual and may generate a schedule for daily, weekly, monthly, and yearly activities for a disabled individual to complete in furtherance of completing goals set by a user. For example, if a goal is to obtain employment, the system may set goals for the user to complete a resume (which may be approved by a an administrator, another user, or the like), obtain clothing for an interview, learn skills required for jobs desired or recommended for a disabled individual, practice interview questions, schedule interviews, arrange for transportation to interviews, arrange for follow-ups to interviews, accept and/or reject job offers and/or the like. In exemplary embodiments, the system may be adapted to schedule tasks for certain times and/or hours of the day in which a disabled individual is most productive, based on data received from all users regarding the disabled individual's most productive times of the day for certain tasks.

In exemplary embodiments, the calendar 158 may be adapted to automate certain tasks and/or assist a disabled individual in completing certain tasks. For example, if one task involves writing a resume, the system may be adapted to pull data saved in the system and automatically generate a resume and/or send data from the system to a professional resume writer and/or the like. The calendar 158 may be adapted to indicate time allocated for tasks in furtherance of goals for each day. In some embodiments, the calendar 158 may generate alerts if a goal is unlikely to be reached due to all scheduled tasks.

In some embodiments, the calendar 158 may be adapted to dynamically reschedule tasks based on updates and data received by the system. In some embodiments, the calendar 158 may be adapted to send notifications to one or more users when a task has been completed, rescheduled, and/or the like. In some embodiments, the calendar 158 may generate and/or provide access to input, transmit, and receive data describing and relating to the schedule of any user and/or multiple users, or the like. For example, each family member, caretaker, advisor, and/or the like for a disabled person may be presented with their own calendar listing recommended activities for each user that interacts with the disabled person or the like. In some embodiments, the system may present a group calendar that displays and coordinates the disabled individual's calendar entries (e.g., tasks, goals, activities, appointments) with the calendars of all other users that may interact with the disabled individual, or the like.

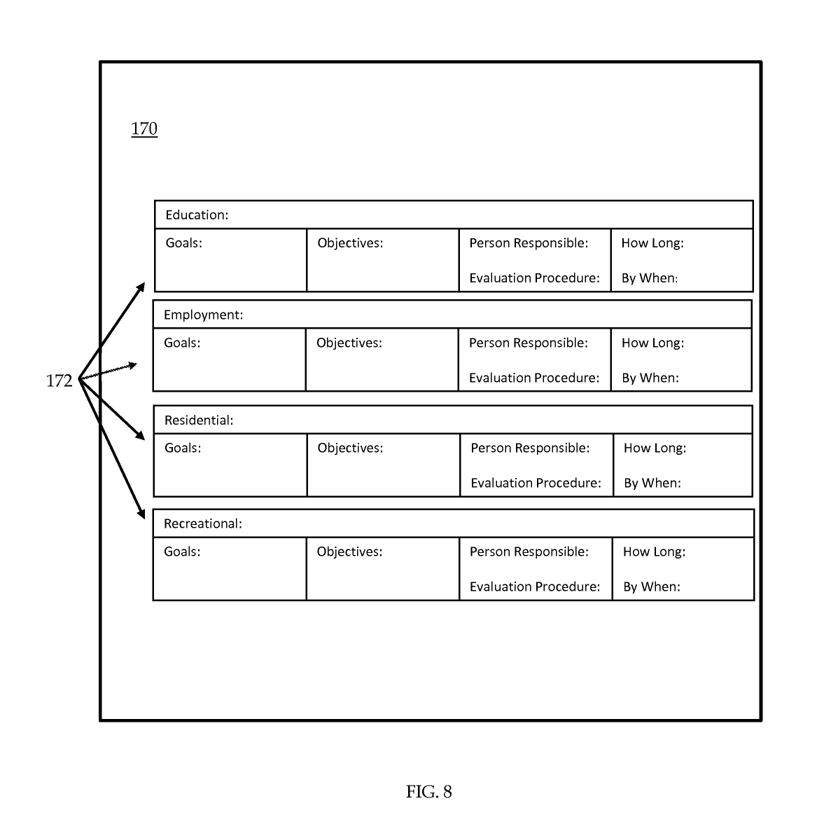

FIG. 8 depicts an exemplary plan interface 170 in accordance with embodiments of the present invention. In some embodiments a plan interface 170 may be accessed via a goal and action plan subcategory tab, and may provide access to enter goal and action plan data. In exemplary embodiments, goal and action plan data may comprise data describing the goals of a disabled individual and the associated actions, objectives, or the like. In some embodiments, goal and action plan data may be separated into various subcategories 172 such as education; employment; residential; recreational; transportation; medical; physical activities; and/or the like. The goal and action plan subcategory tab may provide various interfaces for entering data (e.g., text, video, picture, or the like) relating to each subcategory (e.g., education; employment; residential, or the like).

In some embodiments, the data relating to each subcategory may comprise goals (e.g., the goals if a disabled individual for each subcategory); objectives (e.g., the objectives and/or required activities to accomplish in furtherance of each goal); a person responsible (e.g., a guardian, caretaker, healthcare provider, advisor, or the like who is responsible for overseeing completion of the goals/objectives, setting goals/objectives, modifying goals, eliminating goals/objectives, and/or like); an evaluation procedure; timing (e.g., the time period a disabled individual takes to complete a goal/objective, the time period a disabled individual is expected to take to complete a goal/objective, and/or the like); and/or a deadline field (e.g., a target date and/or time a disabled individual should complete a goal/objective, a deadline for the disabled individual to complete a goal/objective); and/or the like. In some embodiments, the plan interface 170 may provide access to input, transmit, and receive data describing and relating to the goals of any user and/or multiple users, or the like.

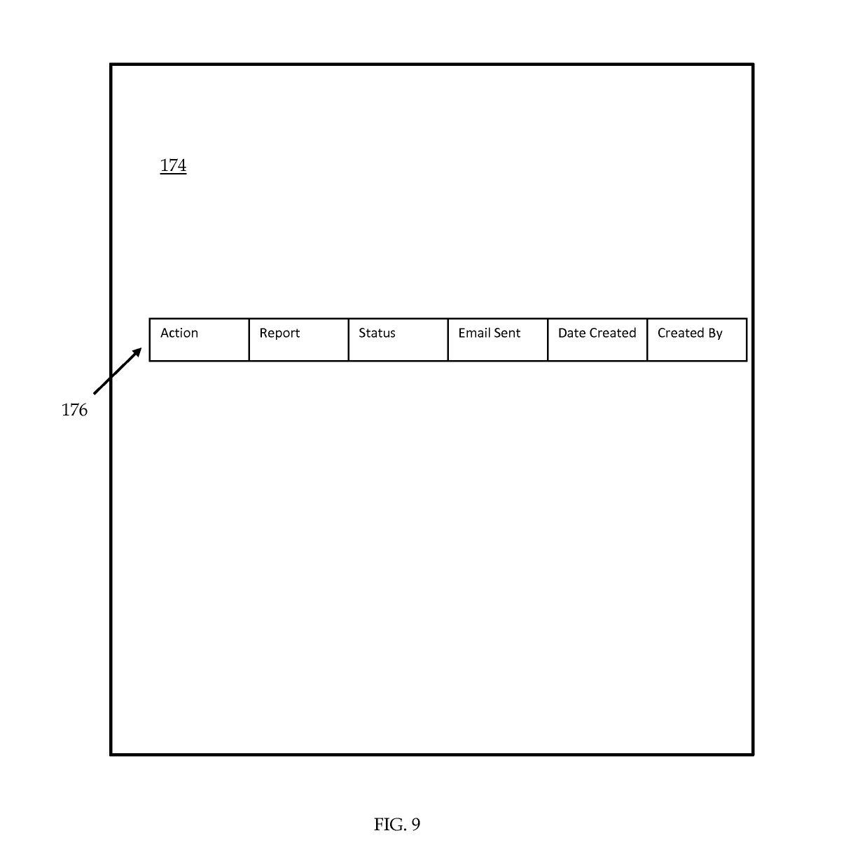

FIG. 9 depicts an exemplary report interface 174 in accordance with embodiments of the present invention. The report interface 174 may display a summary of all actions completed by a disabled individual or another user. In some embodiments, the summary may be broken down into various data categories 176. The data categories 176 may comprise: action (e.g., the name of a task or action a disabled individual or a user has completed); report (e.g., a summary of the task or action); status (e.g., whether a task has been started, is in progress, has been completed, was canceled, or the like); email sent (e.g., whether a notification has been sent to an appropriate party notifying them of a status of an action completed); date created (e.g., the date a task was entered into the system, behavior was observed by a user, a task was set to begin); created by (e.g., the user that entered the task or details about the task in the system); and/or the like. In some embodiments, the report interface 174 may display a summary of all activities related to the care and wellbeing of a disabled individual, or the like.

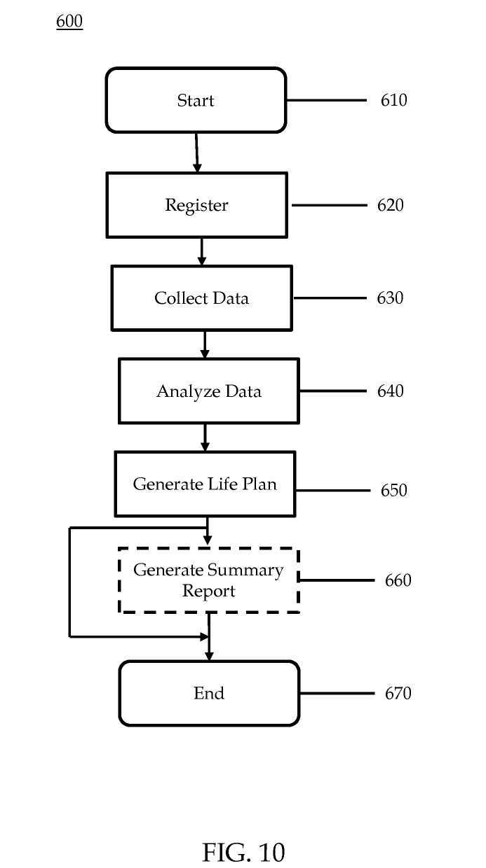

FIG. 10 depicts a flow diagram illustrating a method 600 of generating a life plan in accordance with embodiments of the present invention. The exemplary method 600 begins at step 610 by establishing a system infrastructure such as the one depicted in FIG. 1. At step 620, a user may register with a system in accordance with embodiments of the present invention. A user may comprise any individual having access to the system, such as a disabled individual, a caregiver, a healthcare provider, a counselor, and/or the like. After a user is registered with the system, at step 630, the user may begin entering data regarding the disabled individual, including any of the data described herein and/or the like and the system may store the data and associate the data with the disabled individual. After data is entered into the system and stored, the data may be analyzed at step 640. The data may be analyzed by comparing the data to ideal sets of data entered by an administrator, or the like, and notifying users of discrepancies. In exemplary embodiments, at step 650, a life plan may be generated based on the entered data. The life plan may comprise a summary and/or listing of all data entered for a user (i.e., profile data) and a plan and/or schedule for a user in furtherance of goals generated by the system and/or entered by a user. The life plan may be presented in digital form via a display, transmitted to a user (e.g., in a pdf file format, an email, an html file, a spreadsheet, and/or the like), and may be printed and a physical copy may be generated for use by a user. At optional step 660, a summary report may be generated and sent to a user. A summary report may comprise a summary of all activities completed by a user, by disabled individual, by groups of users, by groups of disabled individuals, by administrators, and/or the like. The summary report may be displayed to the user via a display, transmitted to a user, printed, and/or the like. In exemplary embodiments, the method ends at step 670.

While the foregoing is directed to embodiments of the present invention, other and further embodiments of the invention may be devised without departing from the basic scope thereof. It is also understood that various embodiments described herein may be utilized in combination with any other embodiment described, without departing from the scope contained herein. In addition, embodiments of the present invention are further scalable to allow for additional clients and servers, as particular applications may require.

What is claimed is:

1. A computer-implemented method for generating a life plan for a disabled individual via a global-computer network comprising:
at a computing device having one or more processors and memory storing one or more programs for execution by the one or more processors:
receiving a request to create a user account from an entity and creating the user account;
receiving a request from the user account to create a common profile, the common profile associated with the disabled individual;
generating the common profile and receiving a set of profile data from the user account, the set of profile data comprising information related to the disabled individual and associated with the common profile; and
analyzing the common profile and generating a life plan based on the common profile, the life plan comprising data related to providing guidance to the entity to allow the disabled individual to lead a productive life and increase the independence of the disabled individual.

2. The method of claim 1, wherein the life plan comprises the common profile, a list of goals, a list of available support programs, and a schedule of recommended activities generated by the computing device.

3. The method of claim 1, wherein the common profile stores data received from more than one entity.

4. The method of claim 3, wherein the more than one entity comprises the disabled individual, a guardian, and a medical professional.

5. The method of claim 1, wherein the entity comprises at least one of the disabled individual, a social worker, a healthcare provider, a family member of the disabled individual, a friend of the disabled individual, a caretaker, a counselor, a doctor, a nurse, a physical therapist, a personal trainer, a nutritionist, an insurance company employee, a financial advisor, an academic advisor, and a life coach.

6. The method of claim 1, wherein the set of profile data comprises at least one of medical information, behavioral information, skills information, personality traits, evaluation information, opinions regarding the user, the identity of the person entering the data, relationship data describing interactions of various individuals with the user, guardianship information, responsible payee information, hygiene information, individual limitations of the user, financial information, legal information, the disabled person's income, and the disabled person's expenses.

7. The method of claim 1, wherein the life plan comprises contact information for support professionals tasked with assisting the disabled individual in at least one aspect of the disabled individual's life; and
wherein the method further comprises allowing the disabled individual to contact the support professional via the computing device.

8. The method of claim 1, further comprising:
determining that the disabled individual qualifies for a support program based on the common profile and requirements received from the support program;
generating an application for support from the support program using the common profile;
transmitting the application to the support program; and
monitoring the application and generating a notification if the application is approved or denied.

9. The method of claim 1, further comprising:
receiving a request to create a second user account from a second entity and creating the second user account;
receiving a second set of profile data from the second user account, the second set of profile data comprising information related to the disabled individual and associated with the common profile; and
analyzing the common profile and generating an updated life plan based on the common profile.

10. A computer-implemented method for generating a life plan for a disabled individual via a global-computer network comprising:
at a computing device having one or more processors and memory storing one or more programs for execution by the one or more processors:
receiving a request to create a user account from an entity and creating the user account;
receiving a request from the user account to create a common profile, the common profile associated with the disabled individual;
generating the common profile and receiving a set of profile data from the user account, the set of profile data comprising information related to the disabled individual and associated with the common profile;
analyzing the common profile and generating a life plan based on the common profile, the life plan comprising data related to providing guidance to the entity to allow the disabled individual to lead a productive life and increase the independence of the disabled individual;
determining that the disabled individual qualifies for a support program based on the common profile and requirements received from the support program;
generating an application for support from the support program using the common profile;
transmitting the application to the support program; and
monitoring the application and generating a notification if the application is approved or denied.

11. The method of claim 10, wherein the life plan comprises the common profile, a list of goals, a list of available support programs, and a schedule of recommended activities generated by the computing device.

12. The method of claim 10, wherein the common profile stores data received from more than one entity.

13. The method of claim 12, wherein the more than one entity comprises the disabled individual, a guardian, and a medical professional.

14. The method of claim 10, wherein the entity comprises at least one of the disabled individual, a social worker, a healthcare provider, a family member of the disabled individual, a friend of the disabled individual, a caretaker, a counselor, a doctor, a nurse, a physical therapist, a personal trainer, a nutritionist, an insurance company employee, a financial advisor, an academic advisor, and a life coach.

15. The method of claim 10, wherein the set of profile data comprises at least one of medical information, behavioral information, skills information, personality traits, evaluation information, opinions regarding the user, the identity of the person entering the data, relationship data describing interactions of various individuals with the user, guardianship information, responsible payee information, hygiene information, individual limitations of the user, financial information, legal information, the disabled person's income, and the disabled person's expenses.

16. A computer-implemented method for generating a life plan for a disabled individual via a global-computer network comprising:
at a computing device having one or more processors and memory storing one or more programs for execution by the one or more processors:
receiving a request to create a user account from an entity and creating the user account;
receiving a request from the user account to create a common profile, the common profile associated with the disabled individual;
generating the common profile and receiving a set of profile data from the user account, the set of profile data comprising information related to the disabled individual and associated with the common profile;
analyzing the common profile and generating a life plan based on the common profile, the life plan comprising data related to providing guidance to the entity to allow the disabled individual to lead a productive life and increase the independence of the disabled individual;
receiving a request to create a second user account from a second entity and creating the second user account;
receiving a second set of profile data from the second user account, the second set of profile data comprising information related to the disabled individual and associated with the common profile; and
analyzing the common profile and generating an updated life plan based on the common profile.

17. The method of claim 16, wherein the life plan comprises the common profile, a list of goals, a list of available support programs, and a schedule of recommended activities generated by the computing device.

18. The method of claim 16, wherein the common profile stores data received from more than one entity.

19. The method of claim 18, wherein the more than one entity comprises the disabled individual, a guardian, and a medical professional.

20. The method of claim 16, wherein the entity comprises at least one of the disabled individual, a social worker, a healthcare provider, a family member of the disabled individual, a friend of the disabled individual, a caretaker, a counselor, a doctor, a nurse, a physical therapist, a personal trainer, a nutritionist, an insurance company employee, a financial advisor, an academic advisor, and a life coach.
